(19) United States
(12) Patent Application Publication
(10) Pub. No.: US 2019/0045169 A1
(43) Pub. Date: Feb. 7, 2019

(54) MAXIMIZING EFFICIENCY OF FLIGHT OPTICAL DEPTH SENSORS IN COMPUTING ENVIRONMENTS

(71) Applicant: Intel Corporation, Santa Clara, CA (US)

(72) Inventors: Ohad Menashe, Haifa (IL); Erez Sperling, D.N. Menashe (IL); Aviad Zabatani, Kfar Vitkin (IL); Vitaly Surazhsky, Yokneam Illlit (IL); Michael Bronstein, Lugano (CH); Ron Kimmel, Haifa (IL); Alex Bronstein, Haifa (IL)

(73) Assignee: Intel Corporation, Santa Clara, CA (US)

(21) Appl. No.: 15/992,489

(22) Filed: May 30, 2018

(51) Int. Cl. H04N 13/122; G01S 17/89; G01S 17/42; G01S 7/48; H04N 13/128; H04N 13/254

(52) U.S. Cl. CPC H04N 13/122; G01S 17/89; H04N 13/254; G01S 7/4808; H04N 13/128; G01S 17/42

(57) ABSTRACT

A mechanism is described for facilitating maximizing efficiency of time-of-flight optical depth sensors in computing environments according to one embodiment. An apparatus of embodiments, as described herein, includes detection and observation logic to facilitate a camera to detect and observe a scene and one or more objects in the scene. The apparatus may further include generation, transmission, and reception (GTR) logic to generate a beam of photons based on a transmitted code stored at a memory device, where the GTR logic to transmit the beam of photons to the one or more objects and capture a beam of photons bouncing back from the one or more objects. The apparatus may further include computation and correlation logic to correlate first values of the transmitted code with second values of a returned signal from the one or more objects as the beam of photons.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

Embodiments described herein relate generally to data processing and more particularly to facilitate maximizing efficiency of time-of-flight (TOF) optical depth sensors in computing environments.

### BACKGROUND

Even with the increasing use of time-of-flight cameras and other pertinent sensors and devices, conventional techniques remain deficient, such as in terms of pulse-code modulation (PCM) schemes and their relevant use with TOF devices.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a computing device employing a time-of-flight depth improvement mechanism according to one embodiment.

FIG. 2 illustrates time-of-flight depth improvement mechanism of FIG. 1 according to one embodiment.

FIGS. 3A, 3B, 3C, 3D and 3E illustrate graphs representing workings and properties of novel PCM-based binary codes according to one embodiment.

FIG. 4 illustrates a method for facilitating maximizing efficiency of flight optical depth sensors in computing environments according to one embodiment.

FIG. 5 illustrates a computer device capable of supporting and implementing one or more embodiments according to one embodiment.

FIG. 6 illustrates an embodiment of a computing environment capable of supporting and implementing one or more embodiments according to one embodiment.

### DETAILED DESCRIPTION

In the following description, numerous specific details are set forth. However, embodiments, as described herein, may be practiced without these specific details. In other instances, well-known circuits, structures and techniques have not been shown in detail in order not to obscure the understanding of this description.

Embodiments provide for a novel technique offering efficient cyclic codes for TOF range devices, such as three-dimensional (3D) cameras, using PCM schemes, allowing for lengths that fit unambiguous range of devices. Embodiments further provide for schemes that enable optimal correlation of transmitted signals and echo to obtain accurate depth measurements. This novel technique further provides for maximizing noise immunity and interference resilience, while being practical for analog, optical, and digital TOF systems for transmitting and receiving data.

It is contemplated that terms like “request”, “query”, “job”, “work”, “work item”, and “workload” may be referenced interchangeably throughout this document. Similarly, an “application” or “agent” may refer to or include a computer program, a software application, a game, a workstation application, etc., offered through an application programming interface (API), such as a free rendering API, such as Open Graphics Library (OpenGL®), DirectX® 11, DirectX® 12, etc., where “dispatch” may be interchangeably referred to as “work unit” or “draw” and similarly, “application” may be interchangeably referred to as “workflow” or simply “agent”. For example, a workload, such as that of a three-dimensional (3D) game, may include and issue any number and type of “frames” where each frame may represent an image (e.g., sailboat, human face). Further, each frame may include and offer any number and type of work units, where each work unit may represent a part (e.g., mast of sailboat, forehead of human face) of the image (e.g., sailboat, human face) represented by its corresponding frame. However, for the sake of consistency, each item may be referenced by a single term (e.g., “dispatch”, “agent”, etc.) throughout this document.

In some embodiments, terms like “display screen” and “display surface” may be used interchangeably referring to the visible portion of a display device while the rest of the display device may be embedded into a computing device, such as a smartphone, a wearable device, etc. It is contemplated and to be noted that embodiments are not limited to any particular computing device, software application, hardware component, display device, display screen or surface, protocol, standard, etc. For example, embodiments may be applied to and used with any number and type of real-time applications on any number and type of computers, such as desktops, laptops, tablet computers, smartphones, head-mounted displays and other wearable devices, and/or the like. Further, for example, rendering scenarios for efficient performance using this novel technique may range from simple scenarios, such as desktop compositing, to complex scenarios, such as 3D games, augmented reality applications, etc.

It is to be noted that terms or acronyms like convolutional neural network (CNN), CNN, neural network (NN), NN, deep neural network (DNN), DNN, recurrent neural network (RNN), RNN, and/or the like, may be interchangeably referenced throughout this document. Further, terms like “autonomous machine” or simply “machine”, “autonomous vehicle” or simply “vehicle”, “autonomous agent” or simply “agent”, “autonomous device” or “computing device”, “robot”, and/or the like, may be interchangeably referenced throughout this document.

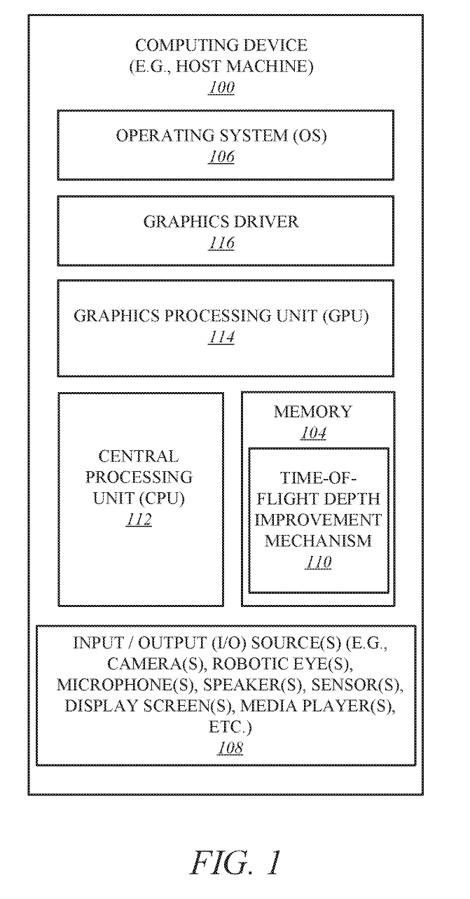

FIG. 1 illustrates a computing device 100 employing a time-of-flight depth improvement mechanism (“TOF mechanism”) 110 according to one embodiment. Computing device 100 represents a communication and data processing device including or representing (without limitations) mobile devices (e.g., smartphones, tablet computers, etc.), gaming devices, handheld devices, wearable devices (e.g., smartwatches, smart bracelets, etc.), virtual reality (VR) devices, head-mounted display (HMDs), Internet of Things (IoT) devices, laptop computers, desktop computers, server computers, set-top boxes (e.g., Internet-based cable television set-top boxes, etc.), global positioning system (GPS)-based devices, etc.

Computing device 100 may also include (without limitations) voice-enabled devices (VEDs), voice command devices (VCDs), etc., that include or works with or are embedded in or facilitate any number and type of smart devices, such as (without limitation) smart command devices or intelligent personal assistants, home/office automation system, home appliances (e.g., washing machines, television sets, etc.),

Computing device 100 may further include (without limitations) autonomous machines or artificially intelligent agents, such as a mechanical agents or machines, electronics agents or machines, virtual agents or machines, electro-mechanical agents or machines, etc. Examples of autonomous machines or artificially intelligent agents may include (without limitation) robots, autonomous vehicles (e.g., self-driving cars, self-flying planes, self-sailing boats, etc.), autonomous equipment (self-operating construction vehicles, self-operating medical equipment, etc.), and/or the like. Further, “autonomous vehicles” are not limed to automobiles but that they may include any number and type of autonomous machines, such as robots, autonomous equipment, household autonomous devices, and/or the like, and any one or more tasks or operations relating to such autonomous machines may be interchangeably referenced with autonomous driving.

Further, for example, computing device 100 may include a computer platform hosting an integrated circuit (“IC”), such as a system on a chip (“SoC” or “SOC”), integrating various hardware and/or software components of computing device 100 on a single chip.

As illustrated, in one embodiment, computing device 100 may include any number and type of hardware and/or software components, such as (without limitation) graphics processing unit (“GPU” or simply “graphics processor”) 114, graphics driver (also referred to as “GPU driver”, “graphics driver logic”, “driver logic”, user-mode driver (UMD), UMD, user-mode driver framework (UMDF), UMDF, or simply “driver”) 116, central processing unit (“CPU” or simply “application processor”) 112, memory 108, network devices, drivers, or the like, as well as input/output (I/O) sources 104, such as touchscreens, touch panels, touch pads, virtual or regular keyboards, virtual or regular mice, ports, connectors, etc. Computing device 100 may include operating system (OS) 106 serving as an interface between hardware and/or physical resources of the computing device 100 and a user.

It is to be appreciated that a lesser or more equipped system than the example described above may be preferred for certain implementations. Therefore, the configuration of computing device 100 may vary from implementation to implementation depending upon numerous factors, such as price constraints, performance requirements, technological improvements, or other circumstances.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The terms “logic”, “module”, “component”, “engine”, and “mechanism” may include, by way of example, software or hardware and/or a combination thereof, such as firmware.

In one embodiment, as illustrated, TOF mechanism 110 may be hosted by memory 108 in communication with I/O source(s) 104, such as microphones, speakers, etc., of voice-enabled device 100. In another embodiment, TOF mechanism 110 may be part of or hosted by operating system 106. In yet another embodiment, TOF mechanism 110 may be hosted or facilitated by graphics driver 116. In yet another embodiment, TOF mechanism 110 may be hosted by or part of graphics processing unit (“GPU” or simply graphics processor”) 114 or firmware of graphics processor 114. For example, TOF mechanism 110 may be embedded in or implemented as part of the processing hardware of graphics processor 114. Similarly, in yet another embodiment, TOF mechanism 110 may be hosted by or part of central processing unit (“CPU” or simply “application processor”) 112. For example, TOF mechanism 110 may be embedded in or implemented as part of the processing hardware of application processor 112.

In yet another embodiment, TOF mechanism 110 may be hosted by or part of any number and type of components of computing device 100, such as a portion of TOF mechanism 110 may be hosted by or part of operating system 116, another portion may be hosted by or part of graphics processor 114, another portion may be hosted by or part of application processor 112, while one or more portions of TOF mechanism 110 may be hosted by or part of operating system 116 and/or any number and type of devices of computing device 100. It is contemplated that embodiments are not limited to certain implementation or hosting of TOF mechanism 110 and that one or more portions or components of TOF mechanism 110 may be employed or implemented as hardware, software, or any combination thereof, such as firmware.

Computing device 100 may host network interface device(s) to provide access to a network, such as a LAN, a wide area network (WAN), a metropolitan area network (MAN), a personal area network (PAN), Bluetooth, a cloud network, a mobile network (e.g., 3^{rd} Generation (3G), 4^{th} Generation (4G), etc.), an intranet, the Internet, etc. Network interface(s) may include, for example, a wireless network interface having antenna, which may represent one or more antenna(e). Network interface(s) may also include, for example, a wired network interface to communicate with remote devices via network cable, which may be, for example, an Ethernet cable, a coaxial cable, a fiber optic cable, a serial cable, or a parallel cable.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

Throughout the document, term “user” may be interchangeably referred to as “viewer”, “observer”, “speaker”, “person”, “individual”, “end-user”, and/or the like. It is to be noted that throughout this document, terms like “graphics domain” may be referenced interchangeably with “graphics processing unit”, “graphics processor”, or simply “GPU” and similarly, “CPU domain” or “host domain” may be referenced interchangeably with “computer processing unit”, “application processor”, or simply “CPU”.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

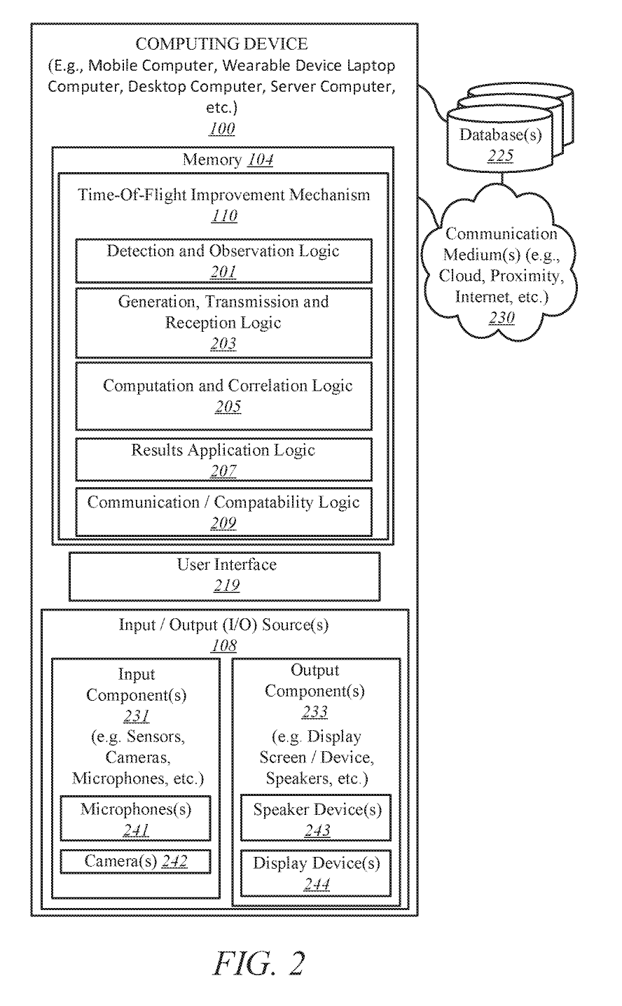

FIG. 2 illustrates time-of-flight depth improvement mechanism 110 of FIG. 1 according to one embodiment. For brevity, many of the details already discussed with reference to FIG. 1 are not repeated or discussed hereafter. In one embodiment, TOF mechanism 110 may include any number and type of components, such as (without limitations): detection and observation logic 201; generation, transmission, and reception logic 203; computation and correlation logic 205; results application logic 207; and communication/compatibility logic 209.

Computing device 100 is further shown to include user interface 219 (e.g., graphical user interface (GUI)-based user interface, Web browser, cloud-based platform user interface, software application-based user interface, other user or application programming interfaces (APIs), etc.). Computing device 100 may further include I/O source(s) 108 having input component(s) 231, such as camera(s) 242 (e.g., Intel® RealSense™ camera, 3D depth camera, such as a light detection and ranging (LIDAR) 3D depth camera, etc.), sensors (e.g., depth sensors), microphone(s) 241, etc., and output component(s) 233, such as display device(s) or simply display(s) 244 (e.g., integral displays, tensor displays, projection screens, display screens, etc.), speaker devices(s) or simply speaker(s) 243, etc.

Computing device 100 is further illustrated as having access to and/or being in communication with one or more database(s) 225 and/or one or more of other computing devices over one or more communication medium(s) 230 (e.g., networks such as a proximity network, a cloud network, the Internet, etc.).

In some embodiments, database(s) 225 may include one or more of storage mediums or devices, repositories, data sources, etc., having any amount and type of information, such as data, metadata, etc., relating to any number and type of applications, such as data and/or metadata relating to one or more users, physical locations or areas, applicable laws, policies and/or regulations, user preferences and/or profiles, security and/or authentication data, historical and/or preferred details, and/or the like.

As aforementioned, computing device 100 may host I/O sources 108 including input component(s) 231 and output component(s) 233. In one embodiment, input component(s) 231 may include a sensor array including, but not limited to, microphone(s) 241 (e.g., ultrasound microphones), camera(s) 242 (e.g., two-dimensional (2D) cameras, three-dimensional (3D) cameras, infrared (IR) cameras, depth-sensing cameras, etc.), capacitors, radio components, radar components, scanners, and/or accelerometers, etc. Similarly, output component(s) 233 may include any number and type of display device(s) 244, projectors, light-emitting diodes (LEDs), speaker(s) 243, and/or vibration motors, etc.

For example, as illustrated, input component(s) 231 may include any number and type of microphones(s) 241, such as multiple microphones or a microphone array, such as ultrasound microphones, dynamic microphones, fiber optic microphones, laser microphones, etc. It is contemplated that one or more of microphone(s) 241 serve as one or more input devices for accepting or receiving audio inputs (such as human voice) into voice-enabled device 100 and converting this audio or sound into electrical signals. Similarly, it is contemplated that one or more of camera(s) 242 serve as one or more input devices for detecting and capturing of image and/or videos of scenes, objects, etc., and provide the captured data as video inputs into computing device 100.

It is contemplated that embodiments are not limited to any number or type of microphone(s) 241, camera(s) 243, speaker(s) 243, display(s) 244, etc. For example, as facilitated by detection and observation logic 201, one or more of microphone(s) 241 may be used to detect speech or sound (e.g., WWR) simultaneously from multiple users or speakers, such as speaker 250. Similarly, as facilitated by detection and observation logic 201, one or more of camera(s) 242 may be used to capture images or videos of a geographic location (such as a room) and its contents (e.g., furniture, electronic devices, humans, animals, plats, etc.) and form a set of images or a video stream.

Similarly, as illustrated, output component(s) 233 may include any number and type of speaker(s) 243 to serve as output devices for outputting or giving out audio from computing device 100 for any number or type of reasons, such as human hearing or consumption. For example, speaker(s) 243 work the opposite of microphone(s) 241 where speaker(s) 243 convert electric signals into sound.

To avoid any potential confusion of terms, it is contemplated and to be noted that “speaker(s)” 250 refers to users or individuals or humans who speak into computing device 100 using their voices or sounds, like WWRs, while “speakers” or “speaker device(s)” 243 are part of output component(s) 233 and refer to one or more output devices coupled to or embedded into computing device 100 to convert electric signals into sound.

As previously described, TOF mechanism 110 provides for an efficient scheme, such as a PCM cyclic coding scheme, for TOF range devices (e.g., 3D cameras, LIDAR 3D cameras, etc.) for encourage efficient workings and depth sensing in such devices, such as through offering a code length that can fit any unambiguous range of devices, while enabling optimal correlation of transmitted signals and echo to obtain accurate depth measurements in such devices. Further, as described above, TOF mechanism 110 further allows for maximizing noise immunity and interference resilience for transmission and reception of data in TOF devices based on systems that are analog, optical, or digital, etc.

In one embodiment, TOF mechanism 110 is used to offer a coding scheme that is workable with any number and type of TOF devices, such as a RealSense® LIDAR 3D depth camera, where the length of the code (e.g., 26-128 bits) is conveniently and efficiently tailored to the usage mode, range, and transmission frequency, etc., used in such cameras.

The novel technique further provides for a coding scheme to optimize good peak-to-side-lobe ratio (PSLR) when transmitted in a cyclic manner. This coding scheme further allows for good intersymbol interference (ISI) or controlled duty cycle not to introduce low frequency components in a signal. Other advantages include energy balance (e.g., amount of 0′=amount of '1 ns), and specifically some of the designed codes are targeting best digital logic utilization, which equals the length of code that is a power of 2.

Conventional PCM code for LIDAR/radio detection and ranging (RADAR)-like 3D cameras offer only a few schemes (e.g., Barker, Gloay, etc.) that are primarily binary codes and are not cyclic. For example, most RADAR codes use {−1,1} codes and since negative optical signals are not physically feasible, a method known as Manchester coding replaces each positive bit by the sequence of {0,1}, and every negative bit by {1,0}, where the code {1,−1,1,−1} re-coded as positive Manchester would then be read as {0,1,1,0,0,1,1,0}. Further, for example a Barker 13 bits code (B13) would become a 26 bits Manchester-Barker code (MB26), where for both the original B13 and the Manchester encoded one MB26, the peak signal to side-lobe ratio (PSLR) equals 13.

In one embodiment, TOF mechanism 110 provides for a novel code scheme of efficient PCM cyclic codes for LIDAR/RADAR applications for corresponding TOF devices. For example, in one embodiment, Manchester coding may be used for encoding phase, where the signal values are balanced so that any reconstruction may utilize Linear Time Invariant (LTI) filters in order to extract the code back.

Further, when using cyclic codes with a kernel without a DC component, the system can be described mathematically in the following manner. For example, the transmitted code is Tx[n] [symbol] {0,1}^{N}, while the corresponding sensed signal is v[n] [symbol] {0, 1}^{N} with an additive white gaussian noise Na[n]. For balanced correlation, the Tx function is represented as T[n] [symbol] {−1,1}^{N}, then the resulting correlation function of c[n] [symbol] R would be defined as:

$${c}_{a} [ n ] = {\sum }_{i = 1}^{N} T [ i ] \cdot ( v [ ( i + n ) \% N ] + {N}_{a} [ i ] ) . \qquad ( 1 )$$

Under an additive white gaussian noise assumption, the above equation may be written as:

$$\begin{matrix}{c}_{a} [ n ] = {\sum }_{i = 1}^{N} T [ i ] \cdot ( v [ ( i + n ) \% N ] + {N}_{a} [ i ] ) \\ = {\sum }_{i = 1}^{N} T [ i ] \cdot v [ ( i + n ) \% N ] + {\sum }_{i = 1}^{N} T [ i ] \cdot {N}_{a} [ i ] \\ = {\sum }_{i = 1}^{N} T [ i ] \cdot v [ ( i + n ) \% N ] + \frac{N}{2} 𝔼 [ {N}_{a} ] .\end{matrix} \qquad ( 2 )$$

Where E[Na] is the estimator of Na[i] and assuming the correlation is with N=2 non-zero bits. An optimal code is defined as a code for which the cyclic autocorrelation with 0 noise has a maximal side-lobe value of one, or in a more formal way, such as assuming k represents the time difference between T[i] and v[i] in a TOF measurement system, Ca[n]<=1 for any n< >k & n [symbol] [k−N, k+N], and Ca[k]=N/2 by design due to the balanced code scheme, where as a result PSLR=N/2.

In one embodiment, detection and observation logic 201 facilitates TOF devices, such as camera(s) 242, to detect, observe, capture scenes and all the objects within the scenes. As discussed earlier, in one embodiment, GRT logic 203 may be used to generate a scheme including a robust code, such as a binary optical code, that is then transmitted from one or more projector associated with camera(s) 242 to an object in the scene and subsequently, a returned signal bounces back from the one or more objects to the one or more sensors associated with camera(s) 242.

In one embodiment, GTR logic 203 may facilitate modulation of a photon emitter at computing device 100, such as by turning the laser on and off, to generate the code, which is then transmitted by GTR logic 203 by putting the code through a wave guide, which serves as an optical device, onto, for example, a mirror (such as a 2D mirror), for scanning purposes. For example, the beam may be put through the mirror to see the objects and then have the returned signal bounce back to all over the place and to the one or more sensors associated with camera(s) 242, where, for example, another sensor near the mirror may capture the bounced back optical information from the returned signal, etc. Further, this scanning of the scene using a mirror can be rather fast, such as 60 scans per second, etc., for each pixel or point in the scene, where having one or more sequences of the code to virtually quantize the entire domain. For example, focusing on the main lobe, negative side lobes, while the rest of the domain be kept as low as possible, so new measures may be defined by which to have maximum top lobe, while keeping the side lobes negative and as small as feasible.

Once the returned signal is captured or received by GTR logic 203, it is then passed on to computation and correlation logic 205 for further processing, such as establishing correlation between the original code that was transmitted and the one that was captured upon bouncing back from the one or more objects. In one embodiment, computation and correlation logic 205 performs correlation or comparison of the original and the returned signals to compute values associated with both codes to then decipher the distance or depth associated with each object, such as the distance between an object and camera(s) 242, through the captured code and its correlation with the original code. For example, the returned signal may be captured using diodes as facilitated by GTR logic 203 to decipher the distance or depth through the captured code.

Further, in one embodiment, computation and correlation logic 205 may be used to compare the original code with the captured code (returning from an object) to establish a correlation profile of each object and camera(s) 242 to keep and maintain for current and future reviews and updates and this process may continue over and over again to collect as much data as feasible. For example, these results, such as distances between various objects and camera(s) 242, may then be communicated on to results application logic 207 to apply these findings to continue to improve the quality of images that the end-users get to view through display device(s) 244. For example, using this novel technique, as facilitated by TOF mechanism 110, the users get to experience a much better depth profile associated with each object and each point within a scene for sharper, deeper, less noisy, and realistic viewing of the scene.

In one embodiment, in comparison of the original and captured codes by computation and correlation logic 205, any photons from the captured beam representing the code are converted into electrons that are then converted back into numbers and then processed by a digital signal processor (DSP) to allow for comparison of the original and captured codes, resulting in numbers that are smoother and less noisier version of the originally-transmitted code. Stated different, correlation by computation and correlation logic 205 provides for isolation of pixels to this distance between the one or more objects and camera(s) 242 is converted into depth for each point in space within the scene.

Now, having the distance, depth, and other correlation results, results application logic 207 is triggered to further evaluate the results by refining and making soother the correlation values so that final result is much closer to a real image. These values are then applied or executed by results application logic 207 through communication/compatibility logic 209 to pass on the benefits of these results to the user/viewers so they may have and enjoy sharper and less noisy images. In one embodiment, the code may be a fixed code, while, in another embodiment, the code may be flexible, sensitive, and modifiable to vary in size and content according to the resources and capacities of computing device 100 and the dynamic nature of the scene, etc., such as when dealing with multiple sensors necessitating multiple modes so they do not interfere with each other.

In some embodiments, the original code may be stored at or hosted by memory 104 in the form of instructions, where, for example, a memory controller at memory 104 may be used and facilitated by GTR logic 203 to activate the photon emitter to the optical version of the code, such as a sequence of photons, that are then transmitted through an optical system. The amplitude of these photons may then be modulated by the code and then passed on to the one or more objects in the scene and then these photons are bounced back as a returned signal from the one or more objects to the one or more sensors associated with camera(s) 242, where this bounced back photons of the returned signal are captured by photo diodes as facilitated by GTR logic 203. These photo diodes translate the optical code from the photons back to electrons that are then converted into values and further into more discrete values and numbers, as facilitated by GTR logic 203, where these discrete values are then processed by a processing unit of a DSP. This then leads to values that are then used for correlation by computation and correlation logic 205 and the results of which are then applied by results application logic 207.

One embodiment of the semantics of the code discussed throughout this document is recited in Table 1 below:

TABLE 1
Menashe8_A = [1 0 1 0 0 1 1 0];
Menashe8_B = [1 0 1 0 1 0 0 1];
Menashe10_A = [1 0 1 0 1 0 0 1 1 0];
Menashe14_A = [1 0 1 0 1 0 0 1 0 1 1 0 0 1];
Menashe22_A = [1 0 1 0 1 0 0 1 0 1 0 1 1 0 0 1 0 1 1 0 0 1];
Menashe26_A = [0 1 1 0 0 1 0 1 0 1 0 1 0 1 1 0 0 1 1 0 1 0 0 1 0 1 ];
Menashe26_B = [1 0 0 1 0 1 0 1 0 1 0 1 0 1 1 0 0 1 1 0 0 1 0 1 1 0 ];
Menashe26_C = [0 1 0 1 0 1 0 1 1 0 0 1 0 1 0 1 1 0 1 0 0 1 1 0 0 1 ];
Menashe26_D = [0 1 1 0 1 0 0 1 1 0 0 1 1 0 1 0 1 0 1 0 1 0 1 0 0 1 ];
Menashe26_E = [1 0 1 0 0 1 0 1 1 0 0 1 1 0 1 0 1 0 1 0 1 0 0 1 1 0 ];
Menashe26_F = [0 1 1 0 1 0 1 0 0 1 1 0 1 0 1 0 1 0 1 0 0 1 1 0 0 1 ];
Menashe26_G = [1 0 1 0 0 1 0 1 1 0 1 0 1 0 1 0 1 0 1 0 0 1 1 0 0 1 ];
Menashe26_H = [1 0 1 0 1 0 1 0 1 0 0 1 0 1 1 0 1 0 0 1 1 0 0 1 1 0 ]; % MB26
%
Menashe32_A = [0 1 1 0 1 0 0 1 0 1 0 1 0 1 1 0 0 1 0 1 1 0 1 0 1 0 0 1 1 0 0 1 ];
Menashe32_B = [0 1 1 0 0 1 0 1 1 0 1 0 0 1 0 1 0 1 1 0 1 0 1 0 1 0 0 1 1 0 0 1 ];
Menashe32_C = [0 1 0 1 0 1 0 1 1 0 1 0 0 1 0 1 1 0 0 1 1 0 1 0 1 0 0 1 0 1 1 0 ];
Menashe32_D = [0 1 1 0 0 1 0 1 0 1 0 1 1 0 1 0 1 0 0 1 0 1 1 0 1 0 0 1 1 0 1 0 ];
Menashe32_E = [0 1 0 1 1 0 1 0 1 0 0 1 0 1 0 1 0 1 1 0 0 1 1 0 1 0 0 1 1 0 1 0 ];
Menashe32_F = [0 1 1 0 1 0 0 1 0 1 1 0 0 1 0 1 1 0 0 1 1 0 1 0 1 0 1 0 0 1 0 1 ];
Menashe32_G = [1 0 0 1 1 0 0 1 0 1 0 1 1 0 1 0 0 1 1 0 1 0 1 0 1 0 0 1 0 1 1 0 ];
Menashe32_H = [0 1 0 1 0 1 1 0 0 1 1 0 1 0 0 1 0 1 1 0 1 0 1 0 1 0 0 1 1 0 1 0 ];
%
Menashe42_A = [0 1 1 0 1 0 0 1 0 1 1 0 0 1 1 0 0 1 0 1 0 1 0 1 0 1 0 1 0 1 1 0 1 0 1 0 0 1 1 0 0 1 ];
Menashe42_B = [0 1 1 0 0 1 0 1 0 1 1 0 1 0 0 1 0 1 0 1 0 1 0 1 0 1 1 0 1 0 0 1 1 0 1 0 0 1 0 1 1 0 ];
Menashe42_C = [0 1 0 1 1 0 0 1 0 1 0 1 1 0 0 1 0 1 0 1 1 0 0 1 0 1 1 0 0 1 1 0 1 0 1 0 1 0 0 1 0 1 ];
Menashe42_D = [1 0 0 1 1 0 1 0 1 0 0 1 1 0 1 0 0 1 1 0 0 1 0 1 0 1 0 1 1 0 1 0 1 0 1 0 0 1 1 0 1 0 ];
Menashe42_E = [0 1 1 0 1 0 1 0 0 1 1 0 0 1 0 1 1 0 0 1 0 1 1 0 1 0 1 0 0 1 1 0 1 0 1 0 1 0 0 1 1 0 ];
Menashe42_F = [1 0 0 1 1 0 0 1 0 1 0 1 1 0 1 0 1 0 0 1 1 0 1 0 0 1 0 1 1 0 1 0 1 0 1 0 1 0 0 1 1 0 ];
Menashe42_G = [0 1 1 0 0 1 1 0 1 0 0 1 0 1 1 0 1 0 0 1 1 0 0 1 1 0 1 0 1 0 1 0 1 0 1 0 1 0 0 1 0 1 ];
Menashe42_H = [0 1 0 1 1 0 1 0 0 1 1 0 0 1 1 0 1 0 1 0 0 1 0 1 1 0 1 0 1 0 1 0 1 0 1 0 0 1 0 1 1 0 ];
%
Menashe46_A = [0 1 0 1 1 0 0 1 1 0 0 1 0 1 1 0 1 0 0 1 0 1 1 0 1 0 0 1 1 0 0 1 1 0 1 0 1 0 1 0 1 0 0
1 0 1 ];
Menashe46_B = [1 0 1 0 0 1 0 1 1 0 1 0 0 1 0 1 1 0 0 1 1 0 0 1 0 1 0 1 0 1 0 1 1 0 1 0 1 0 1 0 0 1 1
0 0 1 ];
%
Menashe52_A = [1 0 1 0 0 1 1 0 0 1 1 0 0 1 1 0 0 1 1 0 1 0 0 1 1 0 0 1 0 1 1 0 1 0 0 1 0 1 0 1 0 1 0
1 0 1 1 0 0 1 0 1 ];
Menashe52_B =
[1 0 1 0 0 1 1 0 0 1 0 1 1 0 0 1 0 1 0 1 1 0 1 0 1 0 0 1 0 1 1 0 0 1 1 0 0 1 1 0 0 1 0 1 0 1 1 0 0 1 1
0 ];
%
Menashe54_A = [0 0 1 0 0 1 0 1 0 0 1 1 0 0 1 0 1 1 0 1 0 1 1 0 1 0 1 1 0 0 1 1 0 0 1 1 0 1 0 0 1 0 1
0 1 0 1 0 1 0 1 0 1 1 ];
Menashe54_B = [0 0 1 0 0 1 0 1 1 0 0 1 1 0 0 1 0 1 0 1 0 1 0 1 0 1 1 0 1 0 0 1 0 1 1 0 0 1 1 0 0 1 0
1 0 1 1 0 1 0 1 0 1 1 ];
Menashe54_C = [0 0 1 0 1 0 0 1 0 1 0 0 1 1 0 0 1 1 0 0 1 0 1 1 0 1 0 1 0 1 0 1 0 1 0 1 0 0 1 1 0 1 1
0 1 0 1 1 0 0 1 1 0 1 ];
Menashe54_D = [0 0 1 0 1 0 1 0 0 1 1 0 1 1 0 1 0 0 1 1 0 0 1 1 0 1 0 1 0 1 0 1 0 1 0 0 1 0 1 1 0 1 0
0 1 1 0 0 1 1 0 1 0 1 ];
%
Menashe58_A = [0 1 0 1 0 1 0 1 0 1 0 1 0 1 1 0 1 0 0 1 1 0 0 1 0 1 1 0 1 0 0 1 1 0 0 1 1 0 0 1 1 0 0
1 0 1 1 0 1 0 1 0 0 1 0 1 1 0 ];
Menashe58_B = [1 0 1 0 0 1 1 0 0 1 0 1 0 1 0 1 1 0 0 1 0 1 1 0 0 1 1 0 0 1 1 0 0 1 0 1 0 1 1 0 0 1 0
1 1 0 1 0 1 0 1 0 0 1 0 1 1 0 ];
Menashe58_C = [0 1 0 1 0 1 1 0 0 1 1 0 0 1 1 0 0 1 0 1 1 0 0 1 0 1 0 1 0 1 1 0 0 1 1 0 1 0 1 0 0 1 0
1 1 0 1 0 1 0 1 0 0 1 0 1 1 0 ];
Menashe58_D = [0 1 1 0 0 1 1 0 0 1 1 0 1 0 1 0 0 1 1 0 1 0 0 1 0 1 0 1 0 1 1 0 1 0 0 1 0 1 0 1 1 0 0
1 1 0 1 0 1 0 1 0 0 1 1 0 1 0 ];
Menashe58_E = [0 1 0 1 1 0 1 0 0 1 0 1 0 1 0 1 1 0 1 0 0 1 1 0 1 0 1 0 0 1 1 0 0 1 1 0 0 1 1 0 1 0 0
1 1 0 1 0 1 0 1 0 0 1 1 0 0 1 ];
Menashe58_F = [1 0 0 1 0 1 0 1 1 0 1 0 0 1 1 0 0 1 1 0 0 1 1 0 0 1 0 1 1 0 1 0 0 1 1 0 0 1 0 1 1 0 1
0 1 0 1 0 1 0 1 0 1 0 0 1 1 0 ];
%
Menashe62_A = [1 0 1 0 0 1 0 1 1 0 0 1 0 1 0 1 0 1 0 1 1 0 0 1 1 0 1 0 1 0 0 1 1 0 1 0 0 1 1 0 0 1 1
0 0 1 0 1 1 0 1 0 1 0 1 0 0 1 0 1 0 1 ];
Menashe62_B = [1 0 0 1 1 0 1 0 0 1 0 1 0 1 0 1 0 1 1 0 0 1 0 1 0 1 1 0 1 0 1 0 0 1 1 0 0 1 1 0 0 1 0
1 1 0 0 1 1 0 1 0 1 0 1 0 0 1 0 1 1 0 ];
Menashe62_C = [1 0 0 1 0 1 0 1 1 0 0 1 0 1 1 0 1 0 1 0 0 1 0 1 0 1 0 1 0 1 1 0 1 0 0 1 0 1 1 0 0 1 1
0 1 0 0 1 1 0 1 0 1 0 1 0 0 1 1 0 0 1 ];
Menashe62_D = [1 0 1 0 0 1 1 0 1 0 1 0 0 1 1 0 0 1 1 0 0 1 0 1 0 1 0 1 1 0 0 1 0 1 1 0 0 1 1 0 1 0 0
1 0 1 1 0 1 0 1 0 1 0 1 0 0 1 0 1 0 1 ];
Menashe62_E = [0 1 0 1 1 0 1 0 1 0 0 1 0 1 0 1 0 1 1 0 1 0 0 1 1 0 0 1 1 0 0 1 0 1 1 0 0 1 0 1 0 1 1
0 0 1 1 0 1 0 1 0 1 0 1 0 0 1 1 0 1 0 ];
Menashe62_F = [0 1 0 1 1 0 1 0 0 1 0 1 0 1 0 1 1 0 0 1 1 0 1 0 0 1 1 0 0 1 1 0 0 1 0 1 0 1 1 0 1 0 1
0 0 1 1 0 1 0 1 0 1 0 1 0 0 1 0 1 1 0 ];
%
Menashe64_A = [0 1 0 1 0 1 1 0 1 0 1 0 0 1 1 0 1 0 0 1 0 1 1 0 1 0 1 0 0 1 1 0 0 1 1 0 0 1 0 1 0 1 0
1 0 1 1 0 0 1 0 1 1 0 0 1 1 0 1 0 1 0 0 1 ];
Menashe64_B = [1 0 1 0 0 1 0 1 0 1 0 1 0 1 0 1 0 1 1 0 1 0 0 1 0 1 1 0 1 0 1 0 1 0 0 1 0 1 0 1 1 0 1
0 0 1 1 0 1 0 0 1 1 0 0 1 1 0 0 1 1 0 0 1 ];
Menashe64_C = [0 1 0 1 1 0 1 0 1 0 0 1 0 1 0 1 0 1 1 0 1 0 0 1 0 1 1 0 1 0 1 0 1 0 1 0 1 0 1 0 0 1 0
1 1 0 0 1 1 0 0 1 1 0 0 1 1 0 0 1 0 1 1 0 ];
Menashe64_D = [1 0 1 0 1 0 0 1 1 0 1 0 1 0 1 0 1 0 0 1 0 1 0 1 0 1 1 0 0 1 0 1 1 0 0 1 0 1 1 0 0 1 0
1 0 1 1 0 1 0 0 1 1 0 0 1 1 0 0 1 0 1 0 1 ];
%
Menashe66_A= [1 0 1 0 0 1 0 1 0 1 0 1 1 0 0 1 1 0 1 0 0 1 0 1 1 0 1 0 1 0 0 1 1 0 0 1 1 0 1 0 0 1 0
1 1 0 0 1 0 1 0 1 0 1 0 1 0 1 0 1 1 0 0 1 1 0 ];
Menashe66_B = [0 1 0 1 1 0 0 1 1 0 1 0 1 0 0 1 1 0 1 0 0 1 0 1 0 1 0 1 1 0 1 0 1 0 0 1 1 0 1 0 0 1 0
1 1 0 0 1 1 0 0 1 0 1 0 1 0 1 0 1 1 0 0 1 0 1 ];
Menashe66_C = [0 1 1 0 1 0 1 0 0 1 0 1 1 0 0 1 0 1 1 0 1 0 1 0 0 1 1 0 0 1 0 1 1 0 0 1 1 0 1 0 1 0 0
1 1 0 0 1 1 0 0 1 0 1 0 1 0 1 0 1 1 0 0 1 0 1 ];
Menashe66_D = [0 1 1 0 0 1 0 1 0 1 0 1 1 0 1 0 1 0 0 1 1 0 0 1 0 1 1 0 0 1 1 0 0 1 0 1 0 1 1 0 1 0 1
0 0 1 1 0 1 0 0 1 0 1 0 1 0 1 0 1 0 1 1 0 0 1 ];
%
Menashe70_A = [1 0 1 0 0 1 0 1 0 1 1 0 0 1 0 1 0 1 0 1 0 1 1 0 1 0 1 0 0 1 0 1 0 1 1 0 0 1 1 0 1 0 0
1 1 0 1 0 0 1 0 1 1 0 0 1 1 0 0 1 1 0 1 0 1 0 1 0 0 1 ];
Menashe70_B = [1 0 0 1 0 1 1 0 1 0 0 1 1 0 0 1 1 0 0 1 0 1 0 1 0 1 1 0 0 1 0 1 1 0 1 0 1 0 0 1 1 0 1
0 1 0 1 0 1 0 0 1 0 1 0 1 1 0 1 0 1 0 0 1 1 0 0 1 0 1 ];
%
Menashe74_A = [1 0 1 0 0 1 1 0 0 1 0 1 1 0 0 1 0 1 0 1 1 0 1 0 1 0 1 0 0 1 0 1 1 0 0 1 0 1 0 1 1 0 0
1 0 1 0 1 1 0 0 1 0 1 0 1 0 1 0 1 0 1 1 0 1 0 1 0 0 1 1 0 0 1 ];
Menashe74_B = [0 1 1 0 1 0 0 1 1 0 1 0 1 0 0 1 0 1 0 1 1 0 1 0 0 1 1 0 0 1 0 1 0 1 1 0 0 1 0 1 0 1 1
0 0 1 1 0 1 0 0 1 0 1 0 1 0 1 0 1 0 1 0 1 0 1 1 0 1 0 0 1 1 0 ];
%
Menashe106_A = [1 0 0 1 0 1 1 0 1 0 1 0 0 1 0 1 1 0 1 0 1 0 1 0 0 1 1 0 0 1 0 1 0 1 1 0 0 1 1 0 1 0
1 0 0 1 0 1 1 0 0 1 0 1 1 0 0 1 0 1 0 1 1 0 0 1 1 0 0 1 0 1 1 0 0 1 1 0 1 0 1 0 0 1 0 1 0 1 0 1 0 1 0 1
0 1 1 0 0 1 0 1 1 0 0 1 ];
Menashe106_B = [0 1 0 1 0 1 1 0 1 0 0 1 0 1 1 0 0 1 0 1 1 0 0 1 1 0 1 0 0 1 1 0 1 0 1 0 1 0 0 1 0 1
0 1 1 0 0 1 0 1 1 0 0 1 1 0 0 1 1 0 0 1 1 0 1 0 1 0 0 1 0 1 0 1 1 0 1 0 1 0 1 0 0 1 0 1 0 1 0 1 0 1 0 1
0 1 0 1 1 0 0 1 0 1 1 0 ];
Menashe106_C = [0 1 1 0 0 1 0 1 0 1 1 0 1 0 1 0 0 1 1 0 1 0 1 0 0 1 1 0 1 0 0 1 0 1 0 1 1 0 0 1 1 0
1 0 0 1 0 1 0 1 1 0 0 1 1 0 0 1 0 1 1 0 1 0 1 0 1 0 0 1 1 0 0 1 0 1 0 1 0 1 0 1 1 0 0 1 0 1 0 1 0 1 0 1
0 1 1 0 1 0 0 1 1 0 0 1 ];
%
Menashe114_A = [0 1 1 0 0 1 1 0 1 0 0 1 1 0 1 0 0 1 1 0 1 0 1 0 0 1 0 1 1 0 0 1 0 1 1 0 1 0 1 0 0 1
1 0 0 1 0 1 1 0 0 1 1 0 0 1 1 0 0 1 1 0 0 1 0 1 0 1 1 0 1 0 1 0 0 1 0 1 1 0 1 0 0 1 0 1 0 1 0 1 0 1 0 1
0 1 0 1 0 1 0 1 0 1 1 0 1 0 1 0 1 0 0 1 ];
%
Menashe124_A = [0 1 1 0 0 1 1 0 0 1 0 1 0 1 1 0 0 1 1 0 1 0 1 0 1 0 1 0 0 1 0 1 0 1 0 1 1 0 1 0 1 0
0 1 1 0 0 1 1 0 1 0 0 1 1 0 0 1 1 0 1 0 0 1 1 0 0 1 0 1 0 1 0 1 0 1 0 1 0 1 0 1 0 1 0 1 1 0 0 1 1 0 1 0
0 1 0 1 1 0 1 0 0 1 0 1 1 0 1 0 0 1 0 1 1 0 1 0 1 0 0 1 0 1 ];
Menashe124_B = [0 1 1 0 1 0 1 0 1 0 0 1 1 0 1 0 1 0 1 0 1 0 0 1 0 1 1 0 0 1 1 0 0 1 1 0 0 1 1 0 0 1
1 0 0 1 0 1 0 1 0 1 1 0 0 1 1 0 1 0 0 1 1 0 0 1 1 0 1 0 1 0 1 0 1 0 0 1 0 1 0 1 0 1 0 1 1 0 0 1 1 0 1 0
0 1 0 1 1 0 1 0 0 1 0 1 1 0 1 0 0 1 0 1 1 0 1 0 1 0 1 0 0 1 ];
Menashe124_C = [0 1 0 1 1 0 0 1 0 1 0 1 0 1 0 1 1 0 0 1 1 0 0 1 1 0 0 1 0 1 1 0 0 1 0 1 0 1 0 1 0 1
1 0 0 1 0 1 1 0 0 1 1 0 1 0 1 0 0 1 1 0 0 1 0 1 1 0 0 1 1 0 1 0 1 0 1 0 0 1 0 1 0 1 0 1 1 0 0 1 1 0 1 0
0 1 0 1 1 0 1 0 0 1 0 1 1 0 1 0 0 1 0 1 1 0 1 0 1 0 1 0 0 1 ];
Menashe124_D = [1 0 1 0 1 0 1 0 1 0 0 1 1 0 1 0 1 0 0 1 1 0 0 1 0 1 1 0 0 1 1 0 0 1 0 1 1 0 1 0 1 0
1 0 0 1 1 0 0 1 1 0 0 1 0 1 1 0 1 0 1 0 1 0 1 0 0 1 0 1 0 1 0 1 1 0 0 1 1 0 0 1 0 1 0 1 1 0 0 1 1 0 1 0
0 1 0 1 1 0 1 0 0 1 0 1 1 0 1 0 0 1 0 1 1 0 1 0 1 0 1 0 0 1 ];
%
Menashe128_A = [1 0 0 1 0 1 1 0 0 1 0 1 1 0 0 1 1 0 1 0 0 1 0 1 0 1 0 1 0 1 1 0 0 1 0 1 0 1 1 0 1 0
0 1 0 1 0 1 1 0 1 0 1 0 1 0 1 0 0 1 0 1 1 0 1 0 1 0 1 0 1 0 1 0 0 1 1 0 1 0 0 1 1 0 0 1 0 1 0 1 0 1 1 0
0 1 1 0 1 0 1 0 1 0 0 1 1 0 0 1 1 0 0 1 0 1 0 1 1 0 0 1 1 0 0 1 1 0 ];
Menashe128_B = [1 0 0 1 0 1 1 0 0 1 0 1 0 1 0 1 1 0 1 0 1 0 1 0 0 1 1 0 1 0 0 1 1 0 1 0 0 1 0 1 1 0
1 0 0 1 1 0 0 1 1 0 0 1 1 0 0 1 1 0 1 0 1 0 0 1 1 0 0 1 1 0 0 1 0 1 1 0 1 0 0 1 0 1 0 1 0 1 0 1 0 1 1 0
0 1 0 1 0 1 0 1 1 0 0 1 1 0 1 0 0 1 0 1 0 1 1 0 0 1 1 0 1 0 1 0 1 0 ];
Menashe128_C = [0 1 1 0 0 1 0 1 1 0 0 1 0 1 1 0 1 0 1 0 1 0 1 0 0 1 1 0 0 1 0 1 0 1 1 0 1 0 1 0 0 1
0 1 0 1 1 0 1 0 0 1 0 1 1 0 0 1 0 1 1 0 1 0 0 1 1 0 0 1 1 0 0 1 1 0 1 0 1 0 1 0 0 1 1 0 0 1 1 0 0 1 0 1
1 0 1 0 1 0 1 0 0 1 1 0 0 1 1 0 1 0 0 1 0 1 0 1 1 0 0 1 0 1 0 1 1 0 ];
Menashe128_D = [1 0 1 0 0 1 1 0 0 1 1 0 0 1 0 1 0 1 1 0 1 0 0 1 0 1 1 0 1 0 0 1 1 0 0 1 0 1 1 0 1 0
1 0 1 0 0 1 1 0 0 1 1 0 1 0 0 1 0 1 0 1 0 1 0 1 1 0 1 0 1 0 1 0 0 1 1 0 0 1 0 1 0 1 1 0 1 0 0 1 0 1 1 0
0 1 0 1 1 0 1 0 0 1 1 0 1 0 1 0 1 0 1 0 0 1 1 0 1 0 1 0 0 1 1 0 1 0 ];
Menashe128_E = [1 0 0 1 1 0 0 1 1 0 1 0 0 1 0 1 1 0 1 0 1 0 1 0 0 1 0 1 1 0 0 1 0 1 0 1 1 0 0 1 0 1
1 0 1 0 1 0 0 1 1 0 0 1 0 1 0 1 1 0 1 0 1 0 0 1 0 1 0 1 0 1 0 1 0 1 0 1 0 1 1 0 1 0 0 1 0 1 1 0 0 1 1 0
1 0 0 1 1 0 0 1 1 0 0 1 1 0 1 0 1 0 1 0 0 1 1 0 1 0 0 1 1 0 0 1 0 1 ];
Menashe128_F = [1 0 0 1 0 1 0 1 1 0 0 1 1 0 1 0 0 1 0 1 1 0 1 0 1 0 0 1 1 0 0 1 0 1 0 1 0 1 0 1 0 1
0 1 0 1 1 0 0 1 0 1 1 0 1 0 1 0 1 0 0 1 1 0 0 1 0 1 1 0 0 1 1 0 1 0 1 0 0 1 0 1 0 1 0 1 1 0 0 1 0 1 1 0
1 0 0 1 1 0 0 1 0 1 1 0 0 1 1 0 0 1 1 0 1 0 0 1 1 0 0 1 1 0 1 0 1 0 ];
%
Menashe256_A = [1 0 1 0 1 0 1 0 0 1 1 0 0 1 1 0 0 1 0 1 1 0 0 1 1 0 0 1 1 0 1 0 0 1 1 0 0 1 1 0 0 1
1 0 0 1 0 1 0 1 1 0 0 1 0 1 1 0 1 0 0 1 0 1 0 1 1 0 0 1 1 0 0 1 1 0 1 0 1 0 1 0 1 0 0 1 1 0 1 0 0 1 1 0
1 0 1 0 1 0 0 1 0 1 1 0 1 0 1 0 0 1 0 1 0 1 1 0 1 0 0 1 0 1 0 1 0 1 0 1 1 0 0 1 0 1 1 0 0 1 1 0 1 0 0 1
1 0 1 0 0 1 1 0 1 0 1 0 0 1 0 1 0 1 0 1 0 1 0 1 0 1 0 1 1 0 0 1 0 1 1 0 0 1 1 0 0 1 0 1 1 0 1 0 0 1 1 0
1 0 0 1 0 1 0 1 1 0 0 1 1 0 0 1 1 0 1 0 0 1 0 1 0 1 0 1 1 0 1 0 1 0 1 0 0 1 1 0 1 0 0 1 1 0 1 0 0 1 0 1
1 0 0 1 0 1 ];

One embodiment of the textual semantics of the code discussed throughout this document is recited in Table 2 below:

TABLE 2
Menashe106_A: set light intensity to high, decrease light intensity, maintain light
intensity, increase light intensity, decrease light intensity, increase light intensity, maintain light
intensity, decrease light intensity, increase light intensity, decrease light intensity, increase light
intensity, decrease light intensity, maintain light intensity, increase light intensity, decrease light
intensity, increase light intensity, maintain light intensity, decrease light intensity, increase light
intensity, decrease light intensity, increase light intensity, decrease light intensity, increase light
intensity, decrease light intensity, maintain light intensity, increase light intensity, maintain light
intensity, decrease light intensity, maintain light intensity, increase light intensity, decrease light
intensity, increase light intensity, decrease light intensity, increase light intensity, maintain light
intensity, decrease light intensity, maintain light intensity, increase light intensity, maintain light
intensity, decrease light intensity, increase light intensity, decrease light intensity, increase light
intensity, decrease light intensity, maintain light intensity, increase light intensity, decrease light
intensity, increase light intensity, maintain light intensity, decrease light intensity, maintain light
intensity, increase light intensity, decrease light intensity, increase light intensity, maintain light
intensity, decrease light intensity, maintain light intensity, increase light intensity, decrease light
intensity, increase light intensity, decrease light intensity, increase light intensity, maintain light
intensity, decrease light intensity, maintain light intensity, increase light intensity, maintain light
intensity, decrease light intensity, maintain light intensity, increase light intensity, decrease light
intensity, increase light intensity, maintain light intensity, decrease light intensity, maintain light
intensity, increase light intensity, maintain light intensity, decrease light intensity, increase light
intensity, decrease light intensity, increase light intensity, decrease light intensity, maintain light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, decrease light
intensity, increase light intensity, maintain light intensity, decrease light intensity, maintain light
intensity, increase light intensity, decrease light intensity, increase light intensity, maintain light
intensity, decrease light intensity, maintain light intensity, increase light intensity.
Menashe106_B: set light intensity to low, increase light intensity, decrease light
intensity, increase light intensity, decrease light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, maintain light intensity, increase light intensity, decrease light
intensity, increase light intensity, maintain light intensity, decrease light intensity, maintain light
intensity, increase light intensity, maintain light intensity, decrease light intensity, increase light
intensity, decrease light intensity, maintain light intensity, increase light intensity, maintain light
intensity, decrease light intensity, increase light intensity, decrease light intensity, increase light
intensity, decrease light intensity, increase light intensity, decrease light intensity, maintain light
intensity, increase light intensity, decrease light intensity, increase light intensity, decrease light
intensity, increase light intensity, maintain light intensity, decrease light intensity, maintain light
intensity, increase light intensity, decrease light intensity, increase light intensity, maintain light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, maintain light
intensity, decrease light intensity, increase light intensity, decrease light intensity, increase light
intensity, decrease light intensity, maintain light intensity, increase light intensity, decrease light
intensity, increase light intensity, decrease light intensity, increase light intensity, maintain light
intensity, decrease light intensity, increase light intensity, decrease light intensity, increase light
intensity, decrease light intensity, increase light intensity, decrease light intensity, maintain light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, maintain light intensity, increase light intensity, decrease light
intensity, increase light intensity, maintain light intensity, decrease light intensity.
Menashe106_C: set light intensity to low, increase light intensity, maintain light
intensity, decrease light intensity, maintain light intensity, increase light intensity, decrease light
intensity, increase light intensity, decrease light intensity, increase light intensity, maintain light
intensity, decrease light intensity, increase light intensity, decrease light intensity, increase light
intensity, decrease light intensity, maintain light intensity, increase light intensity, maintain light
intensity, decrease light intensity, increase light intensity, decrease light intensity, increase light
intensity, decrease light intensity, maintain light intensity, increase light intensity, maintain light
intensity, decrease light intensity, increase light intensity, decrease light intensity, maintain light
intensity, increase light intensity, decrease light intensity, increase light intensity, decrease light
intensity, increase light intensity, maintain light intensity, decrease light intensity, maintain light
intensity, increase light intensity, maintain light intensity, decrease light intensity, increase light
intensity, decrease light intensity, maintain light intensity, increase light intensity, decrease light
intensity, increase light intensity, decrease light intensity, increase light intensity, maintain light
intensity, decrease light intensity, maintain light intensity, increase light intensity, maintain light
intensity, decrease light intensity, maintain light intensity, increase light intensity, decrease light
intensity, increase light intensity, maintain light intensity, decrease light intensity, increase light
intensity, decrease light intensity, increase light intensity, decrease light intensity, increase light
intensity, decrease light intensity, maintain light intensity, increase light intensity, maintain light
intensity, decrease light intensity, maintain light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, maintain light intensity, increase light intensity, decrease light
intensity, increase light intensity, decrease light intensity, increase light intensity, decrease light
intensity, increase light intensity, decrease light intensity, increase light intensity, decrease light
intensity, increase light intensity, maintain light intensity, decrease light intensity, increase light
intensity, decrease light intensity, maintain light intensity, increase light intensity, maintain light
intensity, decrease light intensity, maintain light intensity, increase light intensity.
Menashe10A: set light intensity to high, decrease light intensity, increase light
intensity, decrease light intensity, increase light intensity, decrease light intensity, maintain light
intensity, increase light intensity, maintain light intensity, decrease light intensity.
Menashe114_A: set light intensity to low, increase light intensity, maintain light
intensity, decrease light intensity, maintain light intensity, increase light intensity, maintain light
intensity, decrease light intensity, increase light intensity, decrease light intensity, maintain light
intensity, increase light intensity, maintain light intensity, decrease light intensity, increase light
intensity, decrease light intensity, maintain light intensity, increase light intensity, maintain light
intensity, decrease light intensity, increase light intensity, decrease light intensity, increase light
intensity, decrease light intensity, maintain light intensity, increase light intensity, decrease light
intensity, increase light intensity, maintain light intensity, decrease light intensity, maintain light
intensity, increase light intensity, decrease light intensity, increase light intensity, maintain light
intensity, decrease light intensity, increase light intensity, decrease light intensity, increase light
intensity, decrease light intensity, maintain light intensity, increase light intensity, maintain light
intensity, decrease light intensity, maintain light intensity, increase light intensity, decrease light
intensity, increase light intensity, maintain light intensity, decrease light intensity, maintain light
intensity, increase light intensity, maintain light intensity, decrease light intensity, maintain light
intensity, increase light intensity, maintain light intensity, decrease light intensity, maintain light
intensity, increase light intensity, maintain light intensity, decrease light intensity, maintain light
intensity, increase light intensity, decrease light intensity, increase light intensity, decrease light
intensity, increase light intensity, maintain light intensity, decrease light intensity, increase light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, maintain light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, decrease light
intensity, increase light intensity, maintain light intensity, decrease light intensity, increase light
intensity, decrease light intensity, increase light intensity, decrease light intensity, increase light
intensity, decrease light intensity, maintain light intensity, increase light intensity.
Menashe124_A: set light intensity to low, increase light intensity, maintain light
intensity, decrease light intensity, maintain light intensity, increase light intensity, maintain light
intensity, decrease light intensity, maintain light intensity, increase light intensity, decrease light
intensity, increase light intensity, decrease light intensity, increase light intensity, maintain light
intensity, decrease light intensity, maintain light intensity, increase light intensity, maintain light
intensity, decrease light intensity, increase light intensity, decrease light intensity, increase light
intensity, decrease light intensity, increase light intensity, decrease light intensity, increase light
intensity, decrease light intensity, maintain light intensity, increase light intensity, decrease light
intensity, increase light intensity, decrease light intensity, increase light intensity, decrease light
intensity, increase light intensity, maintain light intensity, decrease light intensity, increase light
intensity, decrease light intensity, increase light intensity, decrease light intensity, maintain light
intensity, increase light intensity, maintain light intensity, decrease light intensity, maintain light
intensity, increase light intensity, maintain light intensity, decrease light intensity, increase light
intensity, decrease light intensity, maintain light intensity, increase light intensity, maintain light
intensity, decrease light intensity, maintain light intensity, increase light intensity, maintain light
intensity, decrease light intensity, increase light intensity, decrease light intensity, maintain light
intensity, increase light intensity, maintain light intensity, decrease light intensity, maintain light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, maintain light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, increase light
intensity, decrease light intensity, maintain light intensity, increase light intensity, decrease light
intensity, increase light intensity.
Menashe124_B: set light intensity to low, increase light intensity, maintain light
intensity, decrease light intensity, increase light intensity, decrease light intensity, increase light
intensity, decrease light intensity, increase light intensity, decrease light intensity, maintain light
intensity, increase light intensity, maintain light intensity, decrease light intensity, increase light
intensity, decrease light intensity, increase light intensity, decrease light intensity, increase light
intensity, decrease light intensity, increase light intensity, decrease light intensity, maintain light
intensity, increase light intensity, decrease light intensity, increase light intensity, maintain light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, decrease light
intensity, increase light intensity, decrease light intensity, increase light intensity, decrease light
intensity, increase light intensity, maintain light intensity, decrease light intensity, maintain light
intensity, increase light intensity, maintain light intensity, decrease light intensity, increase light
intensity, decrease light intensity, maintain light intensity, increase light intensity, maintain light
intensity, decrease light intensity, maintain light intensity, increase light intensity, maintain light
intensity, decrease light intensity, increase light intensity, decrease light intensity, increase light
intensity, decrease light intensity, increase light intensity, decrease light intensity, increase light
intensity, decrease light intensity, maintain light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, maintain light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, increase light
intensity, decrease light intensity, increase light intensity, decrease light intensity, maintain light
intensity, increase light intensity.
Menashe124_C: set light intensity to low, increase light intensity, decrease light
intensity, increase light intensity, maintain light intensity, decrease light intensity, maintain light
intensity, increase light intensity, decrease light intensity, increase light intensity, decrease light
intensity, increase light intensity, decrease light intensity, increase light intensity, decrease light
intensity, increase light intensity, maintain light intensity, decrease light intensity, maintain light
intensity, increase light intensity, maintain light intensity, decrease light intensity, maintain light
intensity, increase light intensity, maintain light intensity, decrease light intensity, maintain light
intensity, increase light intensity, decrease light intensity, increase light intensity, maintain light
intensity, decrease light intensity, maintain light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, maintain light intensity, increase light intensity, decrease light
intensity, increase light intensity, maintain light intensity, decrease light intensity, maintain light
intensity, increase light intensity, maintain light intensity, decrease light intensity, increase light
intensity, decrease light intensity, increase light intensity, decrease light intensity, maintain light
intensity, increase light intensity, maintain light intensity, decrease light intensity, maintain light
intensity, increase light intensity, decrease light intensity, increase light intensity, maintain light
intensity, decrease light intensity, maintain light intensity, increase light intensity, maintain light
intensity, decrease light intensity, increase light intensity, decrease light intensity, increase light
intensity, decrease light intensity, increase light intensity, decrease light intensity, maintain light
intensity, increase light intensity, decrease light intensity, increase light intensity, decrease light
intensity, increase light intensity, decrease light intensity, increase light intensity, maintain light
intensity, decrease light intensity, maintain light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, increase light
intensity, decrease light intensity, increase light intensity, decrease light intensity, maintain light
intensity, increase light intensity.
Menashe124_D: set light intensity to high, decrease light intensity, increase light
intensity, decrease light intensity, increase light intensity, decrease light intensity, increase light
intensity, decrease light intensity, increase light intensity, decrease light intensity, maintain light
intensity, increase light intensity, maintain light intensity, decrease light intensity, increase light
intensity, decrease light intensity, increase light intensity, decrease light intensity, maintain light
intensity, increase light intensity, maintain light intensity, decrease light intensity, maintain light
intensity, increase light intensity, decrease light intensity, increase light intensity, maintain light
intensity, decrease light intensity, maintain light intensity, increase light intensity, maintain light
intensity, decrease light intensity, maintain light intensity, increase light intensity, decrease light
intensity, increase light intensity, maintain light intensity, decrease light intensity, increase light
intensity, decrease light intensity, increase light intensity, decrease light intensity, increase light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, decrease light
intensity, increase light intensity, maintain light intensity, decrease light intensity, increase light
intensity, decrease light intensity, increase light intensity, decrease light intensity, increase light
intensity, decrease light intensity, increase light intensity, decrease light intensity, maintain light
intensity, increase light intensity, decrease light intensity, increase light intensity, decrease light
intensity, increase light intensity, decrease light intensity, increase light intensity, maintain light
intensity, decrease light intensity, maintain light intensity, increase light intensity, maintain light
intensity, decrease light intensity, maintain light intensity, increase light intensity, decrease light
intensity, increase light intensity, decrease light intensity, increase light intensity, maintain light
intensity, decrease light intensity, maintain light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, increase light
intensity, decrease light intensity, increase light intensity, decrease light intensity, maintain light
intensity, increase light intensity.
Menashe128_A: set light intensity to high, decrease light intensity, maintain light
intensity, increase light intensity, decrease light intensity, increase light intensity, maintain light
intensity, decrease light intensity, maintain light intensity, increase light intensity, decrease light
intensity, increase light intensity, maintain light intensity, decrease light intensity, maintain light
intensity, increase light intensity, maintain light intensity, decrease light intensity, increase light
intensity, decrease light intensity, maintain light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, maintain light intensity, increase light intensity, decrease light
intensity, increase light intensity, decrease light intensity, increase light intensity, maintain light
intensity, decrease light intensity, increase light intensity, decrease light intensity, maintain light
intensity, increase light intensity, decrease light intensity, increase light intensity, decrease light
intensity, increase light intensity, maintain light intensity, decrease light intensity, increase light
intensity, decrease light intensity, increase light intensity, decrease light intensity, increase light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, increase light
intensity, decrease light intensity, increase light intensity, decrease light intensity, increase light
intensity, decrease light intensity, increase light intensity, decrease light intensity, maintain light
intensity, increase light intensity, maintain light intensity, decrease light intensity, increase light
intensity, decrease light intensity, maintain light intensity, increase light intensity, maintain light
intensity, decrease light intensity, maintain light intensity, increase light intensity, decrease light
intensity, increase light intensity, decrease light intensity, increase light intensity, decrease light
intensity, increase light intensity, maintain light intensity, decrease light intensity, maintain light
intensity, increase light intensity, maintain light intensity, decrease light intensity, increase light
intensity, decrease light intensity, increase light intensity, decrease light intensity, increase light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, decrease light
intensity, increase light intensity, decrease light intensity, increase light intensity, maintain light
intensity, decrease light intensity, maintain light intensity, increase light intensity, maintain light
intensity, decrease light intensity, maintain light intensity, increase light intensity, maintain light
intensity, decrease light intensity.
Menashe128_B: set light intensity to high, decrease light intensity, maintain light
intensity, increase light intensity, decrease light intensity, increase light intensity, maintain light
intensity, decrease light intensity, maintain light intensity, increase light intensity, decrease light
intensity, increase light intensity, decrease light intensity, increase light intensity, decrease light
intensity, increase light intensity, maintain light intensity, decrease light intensity, increase light
intensity, decrease light intensity, increase light intensity, decrease light intensity, increase light
intensity, decrease light intensity, maintain light intensity, increase light intensity, maintain light
intensity, decrease light intensity, increase light intensity, decrease light intensity, maintain light
intensity, increase light intensity, maintain light intensity, decrease light intensity, increase light
intensity, decrease light intensity, maintain light intensity, increase light intensity, decrease light
intensity, increase light intensity, maintain light intensity, decrease light intensity, increase light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, maintain light
intensity, decrease light intensity, increase light intensity, decrease light intensity, increase light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, decrease light
intensity, increase light intensity, maintain light intensity, decrease light intensity, increase light
intensity, decrease light intensity, maintain light intensity, increase light intensity, decrease light
intensity, increase light intensity, decrease light intensity, increase light intensity, decrease light
intensity, increase light intensity, decrease light intensity, increase light intensity, decrease light
intensity, increase light intensity, maintain light intensity, decrease light intensity, maintain light
intensity, increase light intensity, decrease light intensity, increase light intensity, decrease light
intensity, increase light intensity, decrease light intensity, increase light intensity, maintain light
intensity, decrease light intensity, maintain light intensity, increase light intensity, maintain light
intensity, decrease light intensity, increase light intensity, decrease light intensity, maintain light
intensity, increase light intensity, decrease light intensity, increase light intensity, decrease light
intensity, increase light intensity, maintain light intensity, decrease light intensity, maintain light
intensity, increase light intensity, maintain light intensity, decrease light intensity, increase light
intensity, decrease light intensity, increase light intensity, decrease light intensity, increase light
intensity, decrease light intensity.
Menashe128_C: set light intensity to low, increase light intensity, maintain light
intensity, decrease light intensity, maintain light intensity, increase light intensity, decrease light
intensity, increase light intensity, maintain light intensity, decrease light intensity, maintain light
intensity, increase light intensity, decrease light intensity, increase light intensity, maintain light
intensity, decrease light intensity, increase light intensity, decrease light intensity, increase light
intensity, decrease light intensity, increase light intensity, decrease light intensity, increase light
intensity, decrease light intensity, maintain light intensity, increase light intensity, maintain light
intensity, decrease light intensity, maintain light intensity, increase light intensity, decrease light
intensity, increase light intensity, decrease light intensity, increase light intensity, maintain light
intensity, decrease light intensity, increase light intensity, decrease light intensity, increase light
intensity, decrease light intensity, maintain light intensity, increase light intensity, decrease light
intensity, increase light intensity, decrease light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, maintain light intensity, increase light intensity, decrease light
intensity, increase light intensity, maintain light intensity, decrease light intensity, increase light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, maintain light
intensity, decrease light intensity, increase light intensity, decrease light intensity, increase light
intensity, decrease light intensity, increase light intensity, decrease light intensity, maintain light
intensity, increase light intensity, maintain light intensity, decrease light intensity, maintain light
intensity, increase light intensity, maintain light intensity, decrease light intensity, maintain light
intensity, increase light intensity, decrease light intensity, increase light intensity, maintain light
intensity, decrease light intensity, increase light intensity, decrease light intensity, increase light
intensity, decrease light intensity, increase light intensity, decrease light intensity, maintain light
intensity, increase light intensity, maintain light intensity, decrease light intensity, maintain light
intensity, increase light intensity, maintain light intensity, decrease light intensity, increase light
intensity, decrease light intensity, maintain light intensity, increase light intensity, decrease light
intensity, increase light intensity, decrease light intensity, increase light intensity, maintain light
intensity, decrease light intensity, maintain light intensity, increase light intensity, decrease light
intensity, increase light intensity, decrease light intensity, increase light intensity, maintain light
intensity, decrease light intensity.
Menashe128_D: set light intensity to high, decrease light intensity, increase light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, decrease light
intensity, increase light intensity, decrease light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, maintain light
intensity, increase light intensity, maintain light intensity, decrease light intensity, maintain light
intensity, increase light intensity, decrease light intensity, increase light intensity, maintain light
intensity, decrease light intensity, increase light intensity, decrease light intensity, increase light
intensity, decrease light intensity, increase light intensity, decrease light intensity, maintain light
intensity, increase light intensity, maintain light intensity, decrease light intensity, maintain light
intensity, increase light intensity, maintain light intensity, decrease light intensity, increase light
intensity, decrease light intensity, maintain light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, increase light intensity, decrease light intensity, increase light
intensity, decrease light intensity, increase light intensity, decrease light intensity, maintain light
intensity, increase light intensity, maintain light intensity, decrease light intensity, maintain light
intensity, increase light intensity, decrease light intensity, increase light intensity, decrease light
intensity, increase light intensity, maintain light intensity, decrease light intensity, increase light
intensity, decrease light intensity, maintain light intensity, increase light intensity, decrease light
intensity, increase light intensity, maintain light intensity, decrease light intensity, maintain light
intensity, increase light intensity, decrease light intensity, increase light intensity, maintain light
intensity, decrease light intensity, increase light intensity, decrease light intensity, maintain light
intensity, increase light intensity, maintain light intensity, decrease light intensity, increase light
intensity, decrease light intensity, increase light intensity, decrease light intensity, increase light
intensity, decrease light intensity, increase light intensity, decrease light intensity, maintain light
intensity, increase light intensity, maintain light intensity, decrease light intensity, increase light
intensity, decrease light intensity, increase light intensity, decrease light intensity, maintain light
intensity, increase light intensity, maintain light intensity, decrease light intensity, increase light
intensity, decrease light intensity.
Menashe128_E: set light intensity to high, decrease light intensity, maintain light
intensity, increase light intensity, maintain light intensity, decrease light intensity, maintain light
intensity, increase light intensity, maintain light intensity, decrease light intensity, increase light
intensity, decrease light intensity, maintain light intensity, increase light intensity, decrease light
intensity, increase light intensity, maintain light intensity, decrease light intensity, increase light
intensity, decrease light intensity, increase light intensity, decrease light intensity, increase light
intensity, decrease light intensity, maintain light intensity, increase light intensity, decrease light
intensity, increase light intensity, maintain light intensity, decrease light intensity, maintain light
intensity, increase light intensity, decrease light intensity, increase light intensity, decrease light
intensity, increase light intensity, maintain light intensity, decrease light intensity, maintain light
intensity, increase light intensity, decrease light intensity, increase light intensity, maintain light
intensity, decrease light intensity, increase light intensity, decrease light intensity, increase light
intensity, decrease light intensity, maintain light intensity, increase light intensity, maintain light
intensity, decrease light intensity, maintain light intensity, increase light intensity, decrease light
intensity, increase light intensity, decrease light intensity, increase light intensity, maintain light
intensity, decrease light intensity, increase light intensity, decrease light intensity, increase light
intensity, decrease light intensity, maintain light intensity, increase light intensity, decrease light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, decrease light
intensity, increase light intensity, maintain light intensity, decrease light intensity, increase light
intensity, decrease light intensity, maintain light intensity, increase light intensity, decrease light
intensity, increase light intensity, maintain light intensity, decrease light intensity, maintain light
intensity, increase light intensity, maintain light intensity, decrease light intensity, increase light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, maintain light
intensity, decrease light intensity, increase light intensity, decrease light intensity, increase light
intensity, decrease light intensity, increase light intensity, decrease light intensity, maintain light
intensity, increase light intensity, maintain light intensity, decrease light intensity, increase light
intensity, decrease light intensity, maintain light intensity, increase light intensity, maintain light
intensity, decrease light intensity, maintain light intensity, increase light intensity, decrease light
intensity, increase light intensity.
Menashe128_F: set light intensity to high, decrease light intensity, maintain light
intensity, increase light intensity, decrease light intensity, increase light intensity, decrease light
intensity, increase light intensity, maintain light intensity, decrease light intensity, maintain light
intensity, increase light intensity, maintain light intensity, decrease light intensity, increase light
intensity, decrease light intensity, maintain light intensity, increase light intensity, decrease light
intensity, increase light intensity, maintain light intensity, decrease light intensity, increase light
intensity, decrease light intensity, increase light intensity, decrease light intensity, maintain light
intensity, increase light intensity, maintain light intensity, decrease light intensity, maintain light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, maintain light intensity, increase light intensity, decrease light
intensity, increase light intensity, maintain light intensity, decrease light intensity, increase light
intensity, decrease light intensity, increase light intensity, decrease light intensity, increase light
intensity, decrease light intensity, maintain light intensity, increase light intensity, maintain light
intensity, decrease light intensity, maintain light intensity, increase light intensity, decrease light
intensity, increase light intensity, maintain light intensity, decrease light intensity, maintain light
intensity, increase light intensity, maintain light intensity, decrease light intensity, increase light
intensity, decrease light intensity, increase light intensity, decrease light intensity, maintain light
intensity, increase light intensity, decrease light intensity, increase light intensity, decrease light
intensity, increase light intensity, decrease light intensity, increase light intensity, maintain light
intensity, decrease light intensity, maintain light intensity, increase light intensity, decrease light
intensity, increase light intensity, maintain light intensity, decrease light intensity, increase light
intensity, decrease light intensity, maintain light intensity, increase light intensity, maintain light
intensity, decrease light intensity, maintain light intensity, increase light intensity, decrease light
intensity, increase light intensity, maintain light intensity, decrease light intensity, maintain light
intensity, increase light intensity, maintain light intensity, decrease light intensity, maintain light
intensity, increase light intensity, maintain light intensity, decrease light intensity, increase light
intensity, decrease light intensity, maintain light intensity, increase light intensity, maintain light
intensity, decrease light intensity, maintain light intensity, increase light intensity, maintain light
intensity, decrease light intensity, increase light intensity, decrease light intensity, increase light
intensity, decrease light intensity.
Menashe14_A: set light intensity to high, decrease light intensity, increase light
intensity, decrease light intensity, increase light intensity, decrease light intensity, maintain light
intensity, increase light intensity, decrease light intensity, increase light intensity, maintain light
intensity, decrease light intensity, maintain light intensity, increase light intensity.
Menashe22_A: set light intensity to high, decrease light intensity, increase light
intensity, decrease light intensity, increase light intensity, decrease light intensity, maintain light
intensity, increase light intensity, decrease light intensity, increase light intensity, decrease light
intensity, increase light intensity, maintain light intensity, decrease light intensity, maintain light
intensity, increase light intensity, decrease light intensity, increase light intensity, maintain light
intensity, decrease light intensity, maintain light intensity, increase light intensity.
Menashe256_A: set light intensity to high, decrease light intensity, increase light
intensity, decrease light intensity, increase light intensity, decrease light intensity, increase light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, decrease light
intensity, increase light intensity, maintain light intensity, decrease light intensity, maintain light
intensity, increase light intensity, maintain light intensity, decrease light intensity, maintain light
intensity, increase light intensity, maintain light intensity, decrease light intensity, increase light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, decrease light
intensity, increase light intensity, decrease light intensity, increase light intensity, maintain light
intensity, decrease light intensity, maintain light intensity, increase light intensity, decrease light
intensity, increase light intensity, maintain light intensity, decrease light intensity, increase light
intensity, decrease light intensity, maintain light intensity, increase light intensity, decrease light
intensity, increase light intensity, decrease light intensity, increase light intensity, maintain light
intensity, decrease light intensity, maintain light intensity, increase light intensity, maintain light
intensity, decrease light intensity, maintain light intensity, increase light intensity, maintain light
intensity, decrease light intensity, increase light intensity, decrease light intensity, increase light
intensity, decrease light intensity, increase light intensity, decrease light intensity, increase light
intensity, decrease light intensity, maintain light intensity, increase light intensity, maintain light
intensity, decrease light intensity, increase light intensity, decrease light intensity, maintain light
intensity, increase light intensity, maintain light intensity, decrease light intensity, increase light
intensity, decrease light intensity, increase light intensity, decrease light intensity, increase light
intensity, decrease light intensity, maintain light intensity, increase light intensity, decrease light
intensity, increase light intensity, maintain light intensity, decrease light intensity, increase light
intensity, decrease light intensity, increase light intensity, decrease light intensity, maintain light
intensity, increase light intensity, decrease light intensity, increase light intensity, decrease light
intensity, increase light intensity, maintain light intensity, decrease light intensity, increase light
intensity, decrease light intensity, maintain light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, maintain light intensity, increase light intensity, decrease light
intensity, increase light intensity, maintain light intensity, decrease light intensity, maintain light
intensity, increase light intensity, maintain light intensity, decrease light intensity, increase light
intensity, decrease light intensity, maintain light intensity, increase light intensity, maintain light
intensity, decrease light intensity, increase light intensity, decrease light intensity, maintain light
intensity, increase light intensity, maintain light intensity, decrease light intensity, increase light
intensity, decrease light intensity, increase light intensity, decrease light intensity, maintain light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, maintain light intensity, increase light intensity, decrease light
intensity, increase light intensity, maintain light intensity, decrease light intensity, maintain light
intensity, increase light intensity, maintain light intensity, decrease light intensity, maintain light
intensity, increase light intensity, decrease light intensity, increase light intensity, maintain light
intensity, decrease light intensity, increase light intensity, decrease light intensity, maintain light
intensity, increase light intensity, maintain light intensity, decrease light intensity, increase light
intensity, decrease light intensity, maintain light intensity, increase light intensity, decrease light
intensity, increase light intensity, decrease light intensity, increase light intensity, maintain light
intensity, decrease light intensity, maintain light intensity, increase light intensity, maintain light
intensity, decrease light intensity, maintain light intensity, increase light intensity, maintain light
intensity, decrease light intensity, increase light intensity, decrease light intensity, maintain light
intensity, increase light intensity, decrease light intensity, increase light intensity, decrease light
intensity, increase light intensity, decrease light intensity, increase light intensity, maintain light
intensity, decrease light intensity, increase light intensity, decrease light intensity, increase light
intensity, decrease light intensity, increase light intensity, decrease light intensity, maintain light
intensity, increase light intensity, maintain light intensity, decrease light intensity, increase light
intensity, decrease light intensity, maintain light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, maintain light intensity, increase light intensity, decrease light
intensity, increase light intensity.
Menashe26_A: set light intensity to low, increase light intensity, maintain light
intensity, decrease light intensity, maintain light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, maintain light intensity, increase light intensity, maintain light
intensity, decrease light intensity, increase light intensity, decrease light intensity, maintain light
intensity, increase light intensity, decrease light intensity, increase light intensity.
Menashe26_B: set light intensity to high, decrease light intensity, maintain light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, maintain light intensity, increase light intensity, maintain light
intensity, decrease light intensity, maintain light intensity, increase light intensity, decrease light
intensity, increase light intensity, maintain light intensity, decrease light intensity.
Menashe26_C: set light intensity to low, increase light intensity, decrease light
intensity, increase light intensity, decrease light intensity, increase light intensity, decrease light
intensity, increase light intensity, maintain light intensity, decrease light intensity, maintain light
intensity, increase light intensity, decrease light intensity, increase light intensity, decrease light
intensity, increase light intensity, maintain light intensity, decrease light intensity, increase light
intensity, decrease light intensity, maintain light intensity, increase light intensity, maintain light
intensity, decrease light intensity, maintain light intensity, increase light intensity.
Menashe26_D: set light intensity to low, increase light intensity, maintain light
intensity, decrease light intensity, increase light intensity, decrease light intensity, maintain light
intensity, increase light intensity, maintain light intensity, decrease light intensity, maintain light
intensity, increase light intensity, maintain light intensity, decrease light intensity, increase light
intensity, decrease light intensity, increase light intensity, decrease light intensity, increase light
intensity, decrease light intensity, increase light intensity, decrease light intensity, increase light
intensity, decrease light intensity, maintain light intensity, increase light intensity.
Menashe26_E: set light intensity to high, decrease light intensity, increase light intensity,
decrease light intensity, maintain light intensity, increase light intensity, decrease light intensity,
increase light intensity, maintain light intensity, decrease light intensity, maintain light intensity,
increase light intensity, maintain light intensity, decrease light intensity, increase light intensity,
decrease light intensity, increase light intensity, decrease light intensity, increase light intensity,
decrease light intensity, increase light intensity, decrease light intensity, maintain light intensity,
increase light intensity, maintain light intensity, decrease light intensity.
Menashe26_F: set light intensity to low, increase light intensity, maintain light intensity,
decrease light intensity, increase light intensity, decrease light intensity, increase light intensity,
decrease light intensity, maintain light intensity, increase light intensity, maintain light intensity,
decrease light intensity, increase light intensity, decrease light intensity, increase light intensity,
decrease light intensity, increase light intensity, decrease light intensity, increase light intensity,
decrease light intensity, maintain light intensity, increase light intensity, maintain light intensity,
decrease light intensity, maintain light intensity, increase light intensity.
Menashe26_G: set light intensity to high, decrease light intensity, increase light
intensity, decrease light intensity, maintain light intensity, increase light intensity, decrease light
intensity, increase light intensity, maintain light intensity, decrease light intensity, increase light
intensity, decrease light intensity, increase light intensity, decrease light intensity, increase light
intensity, decrease light intensity, increase light intensity, decrease light intensity, increase light
intensity, decrease light intensity, maintain light intensity, increase light intensity, maintain light
intensity, decrease light intensity, maintain light intensity, increase light intensity.
Menashe26_H: set light intensity to high, decrease light intensity, increase light
intensity, decrease light intensity, increase light intensity, decrease light intensity, increase light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, maintain light
intensity, increase light intensity, maintain light intensity, decrease light intensity, maintain light
intensity, increase light intensity, maintain light intensity, decrease light intensity.
Menashe32_A: set light intensity to low, increase light intensity, maintain light
intensity, decrease light intensity, increase light intensity, decrease light intensity, maintain light
intensity, increase light intensity, decrease light intensity, increase light intensity, decrease light
intensity, increase light intensity, decrease light intensity, increase light intensity, maintain light
intensity, decrease light intensity, maintain light intensity, increase light intensity, decrease light
intensity, increase light intensity, maintain light intensity, decrease light intensity, increase light
intensity, decrease light intensity, increase light intensity, decrease light intensity, maintain light
intensity, increase light intensity, maintain light intensity, decrease light intensity, maintain light
intensity, increase light intensity.
Menashe32_B: set light intensity to low, increase light intensity, maintain light
intensity, decrease light intensity, maintain light intensity, increase light intensity, decrease light
intensity, increase light intensity, maintain light intensity, decrease light intensity, increase light
intensity, decrease light intensity, maintain light intensity, increase light intensity, decrease light
intensity, increase light intensity, decrease light intensity, increase light intensity, maintain light
intensity, decrease light intensity, increase light intensity, decrease light intensity, increase light
intensity, decrease light intensity, increase light intensity, decrease light intensity, maintain light
intensity, increase light intensity, maintain light intensity, decrease light intensity, maintain light
intensity, increase light intensity.
Menashe32_C: set light intensity to low, increase light intensity, decrease light
intensity, increase light intensity, decrease light intensity, increase light intensity, decrease light
intensity, increase light intensity, maintain light intensity, decrease light intensity, increase light
intensity, decrease light intensity, maintain light intensity, increase light intensity, decrease light
intensity, increase light intensity, maintain light intensity, decrease light intensity, maintain light
intensity, increase light intensity, maintain light intensity, decrease light intensity, increase light
intensity, decrease light intensity, increase light intensity, decrease light intensity, maintain light
intensity, increase light intensity, decrease light intensity, increase light intensity, maintain light
intensity, decrease light intensity.
Menashe32_D: set light intensity to low, increase light intensity, maintain light
intensity, decrease light intensity, maintain light intensity, increase light intensity, decrease light
intensity, increase light intensity, decrease light intensity, increase light intensity, decrease light
intensity, increase light intensity, maintain light intensity, decrease light intensity, increase light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, maintain light
intensity, increase light intensity, maintain light intensity, decrease light intensity, increase light
intensity, decrease light intensity.
Menashe32_E: set light intensity to low, increase light intensity, decrease light intensity,
increase light intensity, maintain light intensity, decrease light intensity, increase light intensity,
decrease light intensity, increase light intensity, decrease light intensity, maintain light intensity,
increase light intensity, decrease light intensity, increase light intensity, decrease light intensity,
increase light intensity, decrease light intensity, increase light intensity, maintain light intensity,
decrease light intensity, maintain light intensity, increase light intensity, maintain light intensity,
decrease light intensity, increase light intensity, decrease light intensity, maintain light intensity,
increase light intensity, maintain light intensity, decrease light intensity, increase light intensity,
decrease light intensity.
Menashe32_F: set light intensity to low, increase light intensity, maintain light intensity,
decrease light intensity, increase light intensity, decrease light intensity, maintain light intensity,
increase light intensity, decrease light intensity, increase light intensity, maintain light intensity,
decrease light intensity, maintain light intensity, increase light intensity, decrease light intensity,
increase light intensity, maintain light intensity, decrease light intensity, maintain light intensity,
increase light intensity, maintain light intensity, decrease light intensity, increase light intensity,
decrease light intensity, increase light intensity, decrease light intensity, increase light intensity,
decrease light intensity, maintain light intensity, increase light intensity, decrease light intensity,
increase light intensity.
Menashe32_G: set light intensity to high, decrease light intensity, maintain light
intensity, increase light intensity, maintain light intensity, decrease light intensity, maintain light
intensity, increase light intensity, decrease light intensity, increase light intensity, decrease light
intensity, increase light intensity, maintain light intensity, decrease light intensity, increase light
intensity, decrease light intensity, maintain light intensity, increase light intensity, maintain light
intensity, decrease light intensity, increase light intensity, decrease light intensity, increase light
intensity, decrease light intensity, increase light intensity, decrease light intensity, maintain light
intensity, increase light intensity, decrease light intensity, increase light intensity, maintain light
intensity, decrease light intensity.
Menashe32_H: set light intensity to low, increase light intensity, decrease light
intensity, increase light intensity, decrease light intensity, increase light intensity, maintain light
intensity, decrease light intensity, maintain light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, increase light
intensity, decrease light intensity, increase light intensity, decrease light intensity, maintain light
intensity, increase light intensity, maintain light intensity, decrease light intensity, increase light
intensity, decrease light intensity.
Menashe42_A: set light intensity to low, increase light intensity, maintain light
intensity, decrease light intensity, increase light intensity, decrease light intensity, maintain light
intensity, increase light intensity, decrease light intensity, increase light intensity, maintain light
intensity, decrease light intensity, maintain light intensity, increase light intensity, maintain light
intensity, decrease light intensity, maintain light intensity, increase light intensity, decrease light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, increase light intensity, decrease light intensity, increase light
intensity, decrease light intensity, maintain light intensity, increase light intensity, maintain light
intensity, decrease light intensity, maintain light intensity, increase light intensity.
Menashe42_B: set light intensity to low, increase light intensity, maintain light
intensity, decrease light intensity, maintain light intensity, increase light intensity, decrease light
intensity, increase light intensity, decrease light intensity, increase light intensity, maintain light
intensity, decrease light intensity, increase light intensity, decrease light intensity, maintain light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, increase light intensity, decrease light intensity, maintain light
intensity, increase light intensity, maintain light intensity, decrease light intensity, increase light
intensity, decrease light intensity, maintain light intensity, increase light intensity, decrease light
intensity, increase light intensity, maintain light intensity, decrease light intensity.
Menashe42_C: set light intensity to low, increase light intensity, decrease light
intensity, increase light intensity, maintain light intensity, decrease light intensity, maintain light
intensity, increase light intensity, decrease light intensity, increase light intensity, decrease light
intensity, increase light intensity, maintain light intensity, decrease light intensity, maintain light
intensity, increase light intensity, decrease light intensity, increase light intensity, decrease light
intensity, increase light intensity, maintain light intensity, decrease light intensity, maintain light
intensity, increase light intensity, decrease light intensity, increase light intensity, maintain light
intensity, decrease light intensity, maintain light intensity, increase light intensity, maintain light
intensity, decrease light intensity, increase light intensity, decrease light intensity, increase light
intensity, decrease light intensity, increase light intensity, decrease light intensity, maintain light
intensity, increase light intensity, decrease light intensity, increase light intensity.
Menashe42_D: set light intensity to high, decrease light intensity, maintain light
intensity, increase light intensity, maintain light intensity, decrease light intensity, increase light
intensity, decrease light intensity, increase light intensity, decrease light intensity, maintain light
intensity, increase light intensity, maintain light intensity, decrease light intensity, increase light
intensity, decrease light intensity, maintain light intensity, increase light intensity, maintain light
intensity, decrease light intensity, maintain light intensity, increase light intensity, decrease light
intensity, increase light intensity, decrease light intensity, increase light intensity, decrease light
intensity, increase light intensity, maintain light intensity, decrease light intensity, increase light
intensity, decrease light intensity, increase light intensity, decrease light intensity, increase light
intensity, decrease light intensity, maintain light intensity, increase light intensity, maintain light
intensity, decrease light intensity, increase light intensity, decrease light intensity.
Menashe42_E: set light intensity to low, increase light intensity, maintain light
intensity, decrease light intensity, increase light intensity, decrease light intensity, increase light
intensity, decrease light intensity, maintain light intensity, increase light intensity, maintain light
intensity, decrease light intensity, maintain light intensity, increase light intensity, decrease light
intensity, increase light intensity, maintain light intensity, decrease light intensity, maintain light
intensity, increase light intensity, decrease light intensity, increase light intensity, maintain light
intensity, decrease light intensity, increase light intensity, decrease light intensity, increase light
intensity, decrease light intensity, maintain light intensity, increase light intensity, maintain light
intensity, decrease light intensity, increase light intensity, decrease light intensity, increase light
intensity, decrease light intensity, increase light intensity, decrease light intensity, maintain light
intensity, increase light intensity, maintain light intensity, decrease light intensity.
Menashe42_F: set light intensity to high, decrease light intensity, maintain light
intensity, increase light intensity, maintain light intensity, decrease light intensity, maintain light
intensity, increase light intensity, decrease light intensity, increase light intensity, decrease light
intensity, increase light intensity, maintain light intensity, decrease light intensity, increase light
intensity, decrease light intensity, increase light intensity, decrease light intensity, maintain light
intensity, increase light intensity, maintain light intensity, decrease light intensity, increase light
intensity, decrease light intensity, maintain light intensity, increase light intensity, decrease light
intensity, increase light intensity, maintain light intensity, decrease light intensity, increase light
intensity, decrease light intensity, increase light intensity, decrease light intensity, increase light
intensity, decrease light intensity, increase light intensity, decrease light intensity, maintain light
intensity, increase light intensity, maintain light intensity, decrease light intensity.
Menashe42_G: set light intensity to low, increase light intensity, maintain light
intensity, decrease light intensity, maintain light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, maintain light
intensity, increase light intensity, maintain light intensity, decrease light intensity, maintain light
intensity, increase light intensity, maintain light intensity, decrease light intensity, increase light
intensity, decrease light intensity, increase light intensity, decrease light intensity, increase light
intensity, decrease light intensity, increase light intensity, decrease light intensity, increase light
intensity, decrease light intensity, increase light intensity, decrease light intensity, maintain light
intensity, increase light intensity, decrease light intensity, increase light intensity.
Menashe42_H: set light intensity to low, increase light intensity, decrease light
intensity, increase light intensity, maintain light intensity, decrease light intensity, increase light
intensity, decrease light intensity, maintain light intensity, increase light intensity, maintain light
intensity, decrease light intensity, maintain light intensity, increase light intensity, maintain light
intensity, decrease light intensity, increase light intensity, decrease light intensity, increase light
intensity, decrease light intensity, maintain light intensity, increase light intensity, decrease light
intensity, increase light intensity, maintain light intensity, decrease light intensity, increase light
intensity, decrease light intensity, increase light intensity, decrease light intensity, increase light
intensity, decrease light intensity, increase light intensity, decrease light intensity, increase light
intensity, decrease light intensity, maintain light intensity, increase light intensity, decrease light
intensity, increase light intensity, maintain light intensity, decrease light intensity.
Menashe46_A: set light intensity to low, increase light intensity, decrease light
intensity, increase light intensity, maintain light intensity, decrease light intensity, maintain light
intensity, increase light intensity, maintain light intensity, decrease light intensity, maintain light
intensity, increase light intensity, decrease light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, maintain light
intensity, increase light intensity, maintain light intensity, decrease light intensity, maintain light
intensity, increase light intensity, maintain light intensity, decrease light intensity, increase light
intensity, decrease light intensity, increase light intensity, decrease light intensity, increase light
intensity, decrease light intensity, increase light intensity, decrease light intensity, maintain light
intensity, increase light intensity, decrease light intensity, increase light intensity.
Menashe46_B: set light intensity to high, decrease light intensity, increase light
intensity, decrease light intensity, maintain light intensity, increase light intensity, decrease light
intensity, increase light intensity, maintain light intensity, decrease light intensity, increase light
intensity, decrease light intensity, maintain light intensity, increase light intensity, decrease light
intensity, increase light intensity, maintain light intensity, decrease light intensity, maintain light
intensity, increase light intensity, maintain light intensity, decrease light intensity, maintain light
intensity, increase light intensity, decrease light intensity, increase light intensity, decrease light
intensity, increase light intensity, decrease light intensity, increase light intensity, decrease light
intensity, increase light intensity, maintain light intensity, decrease light intensity, increase light
intensity, decrease light intensity, increase light intensity, decrease light intensity, increase light
intensity, decrease light intensity, maintain light intensity, increase light intensity, maintain light
intensity, decrease light intensity, maintain light intensity, increase light intensity.
Menashe52_A: set light intensity to high, decrease light intensity, increase light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, maintain light
intensity, decrease light intensity, increase light intensity, decrease light intensity, maintain light
intensity, increase light intensity, maintain light intensity, decrease light intensity, maintain light
intensity, increase light intensity, decrease light intensity, increase light intensity, maintain light
intensity, decrease light intensity, increase light intensity, decrease light intensity, maintain light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, maintain light intensity, increase light intensity, decrease light
intensity, increase light intensity.
Menashe52_B: set light intensity to high, decrease light intensity, increase light
intensity, decrease light intensity, maintain light intensity, increase light intensity, maintain light
intensity, decrease light intensity, maintain light intensity, increase light intensity, decrease light
intensity, increase light intensity, maintain light intensity, decrease light intensity, maintain light
intensity, increase light intensity, decrease light intensity, increase light intensity, decrease light
intensity, increase light intensity, maintain light intensity, decrease light intensity, increase light
intensity, decrease light intensity, increase light intensity, decrease light intensity, maintain light
intensity, increase light intensity, decrease light intensity, increase light intensity, maintain light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, decrease light
intensity, increase light intensity, decrease light intensity, increase light intensity, maintain light
intensity, decrease light intensity, maintain light intensity, increase light intensity, maintain light
intensity, decrease light intensity.
Menashe54_A: set light intensity to low, maintain light intensity, increase light
intensity, decrease light intensity, maintain light intensity, increase light intensity, decrease light
intensity, increase light intensity, decrease light intensity, maintain light intensity, increase light
intensity, maintain light intensity, decrease light intensity, maintain light intensity, increase light
intensity, decrease light intensity, increase light intensity, maintain light intensity, decrease light
intensity, increase light intensity, decrease light intensity, increase light intensity, maintain light
intensity, decrease light intensity, increase light intensity, decrease light intensity, increase light
intensity, maintain light intensity, decrease light intensity, maintain light intensity, increase light
intensity, maintain light intensity, decrease light intensity, maintain light intensity, increase light
intensity, maintain light intensity, decrease light intensity, increase light intensity, decrease light
intensity, maintain light intensity, increase light intensity, decrease light intensity, increase light
intensity, decrease light intensity, increase light intensity, decrease light intensity, increase light
intensity, decrease light intensity, increase light intensity, decrease light intensity, increase light
intensity, decrease light intensity, increase light intensity, maintain light intensity.
Menashe54_B: set light intensity to low, maintain light intensity, increase light
intensity, decrease light intensity, maintain light intensity, increase light intensity, decrease light
intensity, increase light intensity, maintain light intensity, decrease light intensity, maintain light
intensity, increase light intensity, maintain light intensity, decrease light intensity, maintain light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, maintain light intensity, increase light intensity, maintain light
intensity, decrease light intensity, maintain light intensity, increase light intensity, decrease light
intensity, increase light intensity, decrease light intensity, increase light intensity, maintain light
intensity, decrease light intensity, increase light intensity, decrease light intensity, increase light
intensity, decrease light intensity, increase light intensity, maintain light intensity.
Menashe54_C: set light intensity to low, maintain light intensity, increase light
intensity, decrease light intensity, increase light intensity, decrease light intensity, maintain light
intensity, increase light intensity, decrease light intensity, increase light intensity, decrease light
intensity, maintain light intensity, increase light intensity, maintain light intensity, decrease light
intensity, maintain light intensity, increase light intensity, maintain light intensity, decrease light
intensity, maintain light intensity, increase light intensity, decrease light intensity, increase light
intensity, maintain light intensity, decrease light intensity, increase light intensity, decrease light
intensity, increase light intensity, decrease light intensity, increase light intensity, decrease light
intensity, increase light intensity, decrease light intensity, increase light intensity, decrease light
intensity, increase light intensity, decrease light intensity, maintain light intensity, increase light
intensity, maintain light intensity, decrease light intensity, increase light intensity, maintain light
intensity, decrease light intensity, increase light intensity, decrease light intensity, increase light
intensity, maintain light intensity, decrease light intensity, maintain light intensity, increase light
intensity, maintain light intensity, decrease light intensity, increase light intensity.
Menashe54_D: set light intensity to low, maintain light intensity, increase light
intensity, decrease light intensity, increase light intensity, decrease light intensity, increase light
intensity, decrease light intensity, maintain light intensity, increase light intensity, maintain light
intensity, decrease light intensity, increase light intensity, maintain light intensity, decrease light
intensity, increase light intensity, decrease light intensity, maintain light intensity, increase light
intensity, maintain light intensity, decrease light intensity, maintain light intensity, increase light
intensity, maintain light intensity, decrease light intensity, increase light intensity, decrease light
intensity, increase light intensity, decrease light intensity, increase light intensity, decrease light
intensity, increase light intensity, decrease light intensity, increase light intensity, decrease light
intensity, maintain light intensity, increase light intensity, decrease light intensity, increase light
intensity, maintain light intensity, decrease light intensity, increase light intensity, decrease light
intensity, maintain light intensity, increase light intensity, maintain light intensity, decrease light
intensity, maintain light intensity, increase light intensity, maintain light intensity, decrease light
intensity, increase light intensity, decrease light intensity, increase light intensity.
Menashe58_A: set light intensity to low, increase light intensity, decrease light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, increase light intensity, decrease light intensity, maintain light
intensity, increase light intensity, maintain light intensity, decrease light intensity, maintain light
intensity, increase light intensity, decrease light intensity, increase light intensity, maintain light
intensity, decrease light intensity, increase light intensity, decrease light intensity, maintain light
intensity, increase light intensity, maintain light intensity, decrease light intensity, maintain light
intensity, increase light intensity, maintain light intensity, decrease light intensity, maintain light
intensity, increase light intensity, maintain light intensity, decrease light intensity, maintain light
intensity, increase light intensity, decrease light intensity, increase light intensity, maintain light
intensity, decrease light intensity, increase light intensity, decrease light intensity, increase light
intensity, decrease light intensity, maintain light intensity, increase light intensity, decrease light
intensity, increase light intensity, maintain light intensity, decrease light intensity.
Menashe58_B: set light intensity to high, decrease light intensity, increase light
intensity, decrease light intensity, maintain light intensity, increase light intensity, maintain light
intensity, decrease light intensity, maintain light intensity, increase light intensity, decrease light
intensity, increase light intensity, decrease light intensity, increase light intensity, decrease light
intensity, increase light intensity, maintain light intensity, decrease light intensity, maintain light
intensity, increase light intensity, decrease light intensity, increase light intensity, maintain light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, decrease light
intensity, increase light intensity, decrease light intensity, increase light intensity, maintain light
intensity, decrease light intensity, maintain light intensity, increase light intensity, decrease light
intensity, increase light intensity, maintain light intensity, decrease light intensity, increase light
intensity, decrease light intensity, increase light intensity, decrease light intensity, increase light
intensity, decrease light intensity, maintain light intensity, increase light intensity, decrease light
intensity, increase light intensity, maintain light intensity, decrease light intensity.
Menashe58_C: set light intensity to low, increase light intensity, decrease light
intensity, increase light intensity, decrease light intensity, increase light intensity, maintain light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, decrease light
intensity, increase light intensity, maintain light intensity, decrease light intensity, maintain light
intensity, increase light intensity, decrease light intensity, increase light intensity, decrease light
intensity, increase light intensity, decrease light intensity, increase light intensity, maintain light
intensity, decrease light intensity, maintain light intensity, increase light intensity, maintain light
intensity, decrease light intensity, increase light intensity, decrease light intensity, increase light
intensity, decrease light intensity, maintain light intensity, increase light intensity, decrease light
intensity, increase light intensity, maintain light intensity, decrease light intensity, increase light
intensity, decrease light intensity, increase light intensity, decrease light intensity, increase light
intensity, decrease light intensity, maintain light intensity, increase light intensity, decrease light
intensity, increase light intensity, maintain light intensity, decrease light intensity.
Menashe58_D: set light intensity to low, increase light intensity, maintain light
intensity, decrease light intensity, maintain light intensity, increase light intensity, maintain light
intensity, decrease light intensity, maintain light intensity, increase light intensity, maintain light
intensity, decrease light intensity, increase light intensity, decrease light intensity, increase light
intensity, decrease light intensity, maintain light intensity, increase light intensity, maintain light
intensity, decrease light intensity, increase light intensity, decrease light intensity, maintain light
intensity, increase light intensity, decrease light intensity, increase light intensity, decrease light
intensity, increase light intensity, decrease light intensity, increase light intensity, maintain light
intensity, decrease light intensity, increase light intensity, decrease light intensity, maintain light
intensity, increase light intensity, decrease light intensity, increase light intensity, decrease light
intensity, increase light intensity, maintain light intensity, decrease light intensity, maintain light
intensity, increase light intensity, maintain light intensity, decrease light intensity, increase light
intensity, decrease light intensity, increase light intensity, decrease light intensity, increase light
intensity, decrease light intensity, maintain light intensity, increase light intensity, maintain light
intensity, decrease light intensity, increase light intensity, decrease light intensity.
Menashe58_E: set light intensity to low, increase light intensity, decrease light intensity,
increase light intensity, maintain light intensity, decrease light intensity, increase light intensity,
decrease light intensity, maintain light intensity, increase light intensity, decrease light intensity,
increase light intensity, decrease light intensity, increase light intensity, decrease light intensity,
increase light intensity, maintain light intensity, decrease light intensity, increase light intensity,
decrease light intensity, maintain light intensity, increase light intensity, maintain light intensity,
decrease light intensity, increase light intensity, decrease light intensity, increase light intensity,
decrease light intensity, maintain light intensity, increase light intensity, maintain light intensity,
decrease light intensity, maintain light intensity, increase light intensity, maintain light intensity,
decrease light intensity, maintain light intensity, increase light intensity, maintain light intensity,
decrease light intensity, increase light intensity, decrease light intensity, maintain light intensity,
increase light intensity, maintain light intensity, decrease light intensity, increase light intensity,
decrease light intensity, increase light intensity, decrease light intensity, increase light intensity,
decrease light intensity, maintain light intensity, increase light intensity, maintain light intensity,
decrease light intensity, maintain light intensity, increase light intensity.
Menashe58_F: set light intensity to high, decrease light intensity, maintain light
intensity, increase light intensity, decrease light intensity, increase light intensity, decrease light
intensity, increase light intensity, maintain light intensity, decrease light intensity, increase light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, decrease light
intensity, increase light intensity, maintain light intensity, decrease light intensity, increase light
intensity, decrease light intensity, maintain light intensity, increase light intensity, maintain light
intensity, decrease light intensity, maintain light intensity, increase light intensity, decrease light
intensity, increase light intensity, maintain light intensity, decrease light intensity, increase light
intensity, decrease light intensity, increase light intensity, decrease light intensity, increase light
intensity, decrease light intensity, increase light intensity, decrease light intensity, increase light
intensity, decrease light intensity, increase light intensity, decrease light intensity, maintain light
intensity, increase light intensity, maintain light intensity, decrease light intensity.
Menashe62_A: set light intensity to high, decrease light intensity, increase light
intensity, decrease light intensity, maintain light intensity, increase light intensity, decrease light
intensity, increase light intensity, maintain light intensity, decrease light intensity, maintain light
intensity, increase light intensity, decrease light intensity, increase light intensity, decrease light
intensity, increase light intensity, decrease light intensity, increase light intensity, decrease light
intensity, increase light intensity, maintain light intensity, decrease light intensity, maintain light
intensity, increase light intensity, maintain light intensity, decrease light intensity, increase light
intensity, decrease light intensity, increase light intensity, decrease light intensity, maintain light
intensity, increase light intensity, maintain light intensity, decrease light intensity, increase light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, decrease light
intensity, increase light intensity, maintain light intensity, decrease light intensity, increase light
intensity, decrease light intensity, increase light intensity, decrease light intensity, increase light
intensity, decrease light intensity, maintain light intensity, increase light intensity, decrease light
intensity, increase light intensity, decrease light intensity, increase light intensity.
Menashe62_B: set light intensity to high, decrease light intensity, maintain light
intensity, increase light intensity, maintain light intensity, decrease light intensity, increase light
intensity, decrease light intensity, maintain light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, maintain light intensity, increase light intensity, decrease light
intensity, increase light intensity, decrease light intensity, increase light intensity, maintain light
intensity, decrease light intensity, increase light intensity, decrease light intensity, increase light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, decrease light
intensity, increase light intensity, maintain light intensity, decrease light intensity, maintain light
intensity, increase light intensity, maintain light intensity, decrease light intensity, increase light
intensity, decrease light intensity, increase light intensity, decrease light intensity, increase light
intensity, decrease light intensity, maintain light intensity, increase light intensity, decrease light
intensity, increase light intensity, maintain light intensity, decrease light intensity.
Menashe62_C: set light intensity to high, decrease light intensity, maintain light
intensity, increase light intensity, decrease light intensity, increase light intensity, decrease light
intensity, increase light intensity, maintain light intensity, decrease light intensity, maintain light
intensity, increase light intensity, decrease light intensity, increase light intensity, maintain light
intensity, decrease light intensity, increase light intensity, decrease light intensity, increase light
intensity, decrease light intensity, maintain light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, maintain light intensity, increase light intensity, maintain light
intensity, decrease light intensity, increase light intensity, decrease light intensity, maintain light
intensity, increase light intensity, maintain light intensity, decrease light intensity, increase light
intensity, decrease light intensity, increase light intensity, decrease light intensity, increase light
intensity, decrease light intensity, maintain light intensity, increase light intensity, maintain light
intensity, decrease light intensity, maintain light intensity, increase light intensity.
Menashe62_D: set light intensity to high, decrease light intensity, increase light
intensity, decrease light intensity, maintain light intensity, increase light intensity, maintain light
intensity, decrease light intensity, increase light intensity, decrease light intensity, increase light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, decrease light
intensity, increase light intensity, decrease light intensity, increase light intensity, decrease light
intensity, increase light intensity, maintain light intensity, decrease light intensity, maintain light
intensity, increase light intensity, decrease light intensity, increase light intensity, maintain light
intensity, decrease light intensity, maintain light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, increase light
intensity, decrease light intensity, increase light intensity, decrease light intensity, increase light
intensity, decrease light intensity, maintain light intensity, increase light intensity, decrease light
intensity, increase light intensity, decrease light intensity, increase light intensity.
Menashe62_E: set light intensity to low, increase light intensity, decrease light intensity,
increase light intensity, maintain light intensity, decrease light intensity, increase light intensity,
decrease light intensity, increase light intensity, decrease light intensity, maintain light intensity,
increase light intensity, decrease light intensity, increase light intensity, decrease light intensity,
increase light intensity, decrease light intensity, increase light intensity, maintain light intensity,
decrease light intensity, increase light intensity, decrease light intensity, maintain light intensity,
increase light intensity, maintain light intensity, decrease light intensity, maintain light intensity,
increase light intensity, maintain light intensity, decrease light intensity, maintain light intensity,
increase light intensity, decrease light intensity, increase light intensity, maintain light intensity,
decrease light intensity, maintain light intensity, increase light intensity, decrease light intensity,
increase light intensity, decrease light intensity, increase light intensity, maintain light intensity,
decrease light intensity, maintain light intensity, increase light intensity, maintain light intensity,
decrease light intensity, increase light intensity, decrease light intensity, increase light intensity,
decrease light intensity, increase light intensity, decrease light intensity, increase light intensity,
decrease light intensity, maintain light intensity, increase light intensity, maintain light intensity,
decrease light intensity, increase light intensity, decrease light intensity.
Menashe62_F: set light intensity to low, increase light intensity, decrease light intensity,
increase light intensity, maintain light intensity, decrease light intensity, increase light intensity,
decrease light intensity, maintain light intensity, increase light intensity, decrease light intensity,
increase light intensity, decrease light intensity, increase light intensity, decrease light intensity,
increase light intensity, maintain light intensity, decrease light intensity, maintain light intensity,
increase light intensity, maintain light intensity, decrease light intensity, increase light intensity,
decrease light intensity, maintain light intensity, increase light intensity, maintain light intensity,
decrease light intensity, maintain light intensity, increase light intensity, maintain light intensity,
decrease light intensity, maintain light intensity, increase light intensity, decrease light intensity,
increase light intensity, decrease light intensity, increase light intensity, maintain light intensity,
decrease light intensity, increase light intensity, decrease light intensity, increase light intensity,
decrease light intensity, maintain light intensity, increase light intensity, maintain light intensity,
decrease light intensity, increase light intensity, decrease light intensity, increase light intensity,
decrease light intensity, increase light intensity, decrease light intensity, increase light intensity,
decrease light intensity, maintain light intensity, increase light intensity, decrease light intensity,
increase light intensity, maintain light intensity, decrease light intensity.
Menashe64_A: set light intensity to low, increase light intensity, decrease light
intensity, increase light intensity, decrease light intensity, increase light intensity, maintain light
intensity, decrease light intensity, increase light intensity, decrease light intensity, increase light
intensity, decrease light intensity, maintain light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, increase light
intensity, decrease light intensity, maintain light intensity, increase light intensity, maintain light
intensity, decrease light intensity, maintain light intensity, increase light intensity, maintain light
intensity, decrease light intensity, maintain light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, maintain light intensity, increase light intensity, decrease light
intensity, increase light intensity, maintain light intensity, decrease light intensity, maintain light
intensity, increase light intensity, maintain light intensity, decrease light intensity, increase light
intensity, decrease light intensity, increase light intensity, decrease light intensity, maintain light
intensity, increase light intensity.
Menashe64_B: set light intensity to high, decrease light intensity, increase light
intensity, decrease light intensity, maintain light intensity, increase light intensity, decrease light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, increase light
intensity, decrease light intensity, increase light intensity, decrease light intensity, maintain light
intensity, increase light intensity, decrease light intensity, increase light intensity, decrease light
intensity, increase light intensity, maintain light intensity, decrease light intensity, increase light
intensity, decrease light intensity, maintain light intensity, increase light intensity, maintain light
intensity, decrease light intensity, increase light intensity, decrease light intensity, maintain light
intensity, increase light intensity, maintain light intensity, decrease light intensity, maintain light
intensity, increase light intensity, maintain light intensity, decrease light intensity, maintain light
intensity, increase light intensity, maintain light intensity, decrease light intensity, maintain light
intensity, increase light intensity.
Menashe64_C: set light intensity to low, increase light intensity, decrease light
intensity, increase light intensity, maintain light intensity, decrease light intensity, increase light
intensity, decrease light intensity, increase light intensity, decrease light intensity, maintain light
intensity, increase light intensity, decrease light intensity, increase light intensity, decrease light
intensity, increase light intensity, decrease light intensity, increase light intensity, maintain light
intensity, decrease light intensity, increase light intensity, decrease light intensity, maintain light
intensity, increase light intensity, decrease light intensity, increase light intensity, maintain light
intensity, decrease light intensity, increase light intensity, decrease light intensity, increase light
intensity, decrease light intensity, increase light intensity, decrease light intensity, increase light
intensity, decrease light intensity, increase light intensity, decrease light intensity, increase light
intensity, decrease light intensity, maintain light intensity, increase light intensity, decrease light
intensity, increase light intensity, maintain light intensity, decrease light intensity, maintain light
intensity, increase light intensity, maintain light intensity, decrease light intensity, maintain light
intensity, increase light intensity, maintain light intensity, decrease light intensity, maintain light
intensity, increase light intensity, maintain light intensity, decrease light intensity, maintain light
intensity, increase light intensity, decrease light intensity, increase light intensity, maintain light
intensity, decrease light intensity.
Menashe64_D: set light intensity to high, decrease light intensity, increase light
intensity, decrease light intensity, increase light intensity, decrease light intensity, maintain light
intensity, increase light intensity, maintain light intensity, decrease light intensity, increase light
intensity, decrease light intensity, increase light intensity, decrease light intensity, increase light
intensity, decrease light intensity, increase light intensity, decrease light intensity, maintain light
intensity, increase light intensity, decrease light intensity, increase light intensity, decrease light
intensity, increase light intensity, decrease light intensity, increase light intensity, maintain light
intensity, decrease light intensity, maintain light intensity, increase light intensity, decrease light
intensity, increase light intensity, maintain light intensity, decrease light intensity, maintain light
intensity, increase light intensity, decrease light intensity, increase light intensity, maintain light
intensity, decrease light intensity, maintain light intensity, increase light intensity, decrease light
intensity, increase light intensity, decrease light intensity, increase light intensity, maintain light
intensity, decrease light intensity, increase light intensity, decrease light intensity, maintain light
intensity, increase light intensity, maintain light intensity, decrease light intensity, maintain light
intensity, increase light intensity, maintain light intensity, decrease light intensity, maintain light
intensity, increase light intensity, decrease light intensity, increase light intensity, decrease light
intensity, increase light intensity.
Menashe66_A: set light intensity to high, decrease light intensity, increase light
intensity, decrease light intensity, maintain light intensity, increase light intensity, decrease light
intensity, increase light intensity, decrease light intensity, increase light intensity, decrease light
intensity, increase light intensity, maintain light intensity, decrease light intensity, maintain light
intensity, increase light intensity, maintain light intensity, decrease light intensity, increase light
intensity, decrease light intensity, maintain light intensity, increase light intensity, decrease light
intensity, increase light intensity, maintain light intensity, decrease light intensity, increase light
intensity, decrease light intensity, increase light intensity, decrease light intensity, maintain light
intensity, increase light intensity, maintain light intensity, decrease light intensity, maintain light
intensity, increase light intensity, maintain light intensity, decrease light intensity, increase light
intensity, decrease light intensity, maintain light intensity, increase light intensity, decrease light
intensity, increase light intensity, maintain light intensity, decrease light intensity, maintain light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, decrease light
intensity, increase light intensity, maintain light intensity, decrease light intensity, maintain light
intensity, increase light intensity, maintain light intensity, decrease light intensity.
Menashe66_B: set light intensity to low, increase light intensity, decrease light
intensity, increase light intensity, maintain light intensity, decrease light intensity, maintain light
intensity, increase light intensity, maintain light intensity, decrease light intensity, increase light
intensity, decrease light intensity, increase light intensity, decrease light intensity, maintain light
intensity, increase light intensity, maintain light intensity, decrease light intensity, increase light
intensity, decrease light intensity, maintain light intensity, increase light intensity, decrease light
intensity, increase light intensity, decrease light intensity, increase light intensity, decrease light
intensity, increase light intensity, maintain light intensity, decrease light intensity, increase light
intensity, decrease light intensity, increase light intensity, decrease light intensity, maintain light
intensity, increase light intensity, maintain light intensity, decrease light intensity, increase light
intensity, decrease light intensity, maintain light intensity, increase light intensity, decrease light
intensity, increase light intensity, maintain light intensity, decrease light intensity, maintain light
intensity, increase light intensity, maintain light intensity, decrease light intensity, maintain light
intensity, increase light intensity, decrease light intensity, increase light intensity, decrease light
intensity, increase light intensity, decrease light intensity, increase light intensity, decrease light
intensity, increase light intensity, maintain light intensity, decrease light intensity, maintain light
intensity, increase light intensity, decrease light intensity, increase light intensity.
Menashe66_C: set light intensity to low, increase light intensity, maintain light
intensity, decrease light intensity, increase light intensity, decrease light intensity, increase light
intensity, decrease light intensity, maintain light intensity, increase light intensity, decrease light
intensity, increase light intensity, maintain light intensity, decrease light intensity, maintain light
intensity, increase light intensity, decrease light intensity, increase light intensity, maintain light
intensity, decrease light intensity, increase light intensity, decrease light intensity, increase light
intensity, decrease light intensity, maintain light intensity, increase light intensity, maintain light
intensity, decrease light intensity, maintain light intensity, increase light intensity, decrease light
intensity, increase light intensity, maintain light intensity, decrease light intensity, maintain light
intensity, increase light intensity, maintain light intensity, decrease light intensity, increase light
intensity, decrease light intensity, increase light intensity, decrease light intensity, maintain light
intensity, increase light intensity, maintain light intensity, decrease light intensity, maintain light
intensity, increase light intensity, maintain light intensity, decrease light intensity, maintain light
intensity, increase light intensity, decrease light intensity, increase light intensity, decrease light
intensity, increase light intensity, decrease light intensity, increase light intensity, decrease light
intensity, increase light intensity, maintain light intensity, decrease light intensity, maintain light
intensity, increase light intensity, decrease light intensity, increase light intensity.
Menashe66_D: set light intensity to low, increase light intensity, maintain light
intensity, decrease light intensity, maintain light intensity, increase light intensity, decrease light
intensity, increase light intensity, decrease light intensity, increase light intensity, decrease light
intensity, increase light intensity, maintain light intensity, decrease light intensity, increase light
intensity, decrease light intensity, increase light intensity, decrease light intensity, maintain light
intensity, increase light intensity, maintain light intensity, decrease light intensity, maintain light
intensity, increase light intensity, decrease light intensity, increase light intensity, maintain light
intensity, decrease light intensity, maintain light intensity, increase light intensity, maintain light
intensity, decrease light intensity, maintain light intensity, increase light intensity, decrease light
intensity, increase light intensity, decrease light intensity, increase light intensity, maintain light
intensity, decrease light intensity, increase light intensity, decrease light intensity, increase light
intensity, decrease light intensity, maintain light intensity, increase light intensity, maintain light
intensity, decrease light intensity, increase light intensity, decrease light intensity, maintain light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, maintain light intensity, increase light intensity.
Menashe70_A: set light intensity to high, decrease light intensity, increase light
intensity, decrease light intensity, maintain light intensity, increase light intensity, decrease light
intensity, increase light intensity, decrease light intensity, increase light intensity, maintain light
intensity, decrease light intensity, maintain light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, increase light intensity, decrease light intensity, increase light
intensity, decrease light intensity, maintain light intensity, increase light intensity, decrease light
intensity, increase light intensity, decrease light intensity, increase light intensity, maintain light
intensity, decrease light intensity, maintain light intensity, increase light intensity, maintain light
intensity, decrease light intensity, increase light intensity, decrease light intensity, maintain light
intensity, increase light intensity, maintain light intensity, decrease light intensity, increase light
intensity, decrease light intensity, maintain light intensity, increase light intensity, decrease light
intensity, increase light intensity, maintain light intensity, decrease light intensity, maintain light
intensity, increase light intensity, maintain light intensity, decrease light intensity, maintain light
intensity, increase light intensity, maintain light intensity, decrease light intensity, increase light
intensity, decrease light intensity, increase light intensity, decrease light intensity, increase light
intensity, decrease light intensity, maintain light intensity, increase light intensity.
Menashe70_B: set light intensity to high, decrease light intensity, maintain light
intensity, increase light intensity, decrease light intensity, increase light intensity, maintain light
intensity, decrease light intensity, increase light intensity, decrease light intensity, maintain light
intensity, increase light intensity, maintain light intensity, decrease light intensity, maintain light
intensity, increase light intensity, maintain light intensity, decrease light intensity, maintain light
intensity, increase light intensity, decrease light intensity, increase light intensity, decrease light
intensity, increase light intensity, decrease light intensity, increase light intensity, maintain light
intensity, decrease light intensity, maintain light intensity, increase light intensity, decrease light
intensity, increase light intensity, maintain light intensity, decrease light intensity, increase light
intensity, decrease light intensity, increase light intensity, decrease light intensity, maintain light
intensity, increase light intensity, maintain light intensity, decrease light intensity, increase light
intensity, decrease light intensity, increase light intensity, decrease light intensity, increase light
intensity, decrease light intensity, increase light intensity, decrease light intensity, maintain light
intensity, increase light intensity, decrease light intensity, increase light intensity, decrease light
intensity, increase light intensity, maintain light intensity, decrease light intensity, increase light
intensity, decrease light intensity, increase light intensity, decrease light intensity, maintain light
intensity, increase light intensity, maintain light intensity, decrease light intensity, maintain light
intensity, increase light intensity, decrease light intensity, increase light intensity.
Menashe74_A: set light intensity to high, decrease light intensity, increase light
intensity, decrease light intensity, maintain light intensity, increase light intensity, maintain light
intensity, decrease light intensity, maintain light intensity, increase light intensity, decrease light
intensity, increase light intensity, maintain light intensity, decrease light intensity, maintain light
intensity, increase light intensity, decrease light intensity, increase light intensity, decrease light
intensity, increase light intensity, maintain light intensity, decrease light intensity, increase light
intensity, decrease light intensity, increase light intensity, decrease light intensity, increase light
intensity, decrease light intensity, maintain light intensity, increase light intensity, decrease light
intensity, increase light intensity, maintain light intensity, decrease light intensity, maintain light
intensity, increase light intensity, decrease light intensity, increase light intensity, decrease light
intensity, increase light intensity, maintain light intensity, decrease light intensity, maintain light
intensity, increase light intensity, decrease light intensity, increase light intensity, decrease light
intensity, increase light intensity, maintain light intensity, decrease light intensity, maintain light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, increase light intensity, decrease light intensity, increase light
intensity, decrease light intensity, maintain light intensity, increase light intensity, maintain light
intensity, decrease light intensity, maintain light intensity, increase light intensity.
Menashe74_B: set light intensity to low, increase light intensity, maintain light
intensity, decrease light intensity, increase light intensity, decrease light intensity, maintain light
intensity, increase light intensity, maintain light intensity, decrease light intensity, increase light
intensity, decrease light intensity, increase light intensity, decrease light intensity, maintain light
intensity, increase light intensity, decrease light intensity, increase light intensity, decrease light
intensity, increase light intensity, maintain light intensity, decrease light intensity, increase light
intensity, decrease light intensity, maintain light intensity, increase light intensity, maintain light
intensity, decrease light intensity, maintain light intensity, increase light intensity, decrease light
intensity, increase light intensity, decrease light intensity, increase light intensity, maintain light
intensity, decrease light intensity, maintain light intensity, increase light intensity, decrease light
intensity, increase light intensity, decrease light intensity, increase light intensity, maintain light
intensity, decrease light intensity, maintain light intensity, increase light intensity, maintain light
intensity, decrease light intensity, increase light intensity, decrease light intensity, maintain light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, decrease light
intensity, increase light intensity, decrease light intensity, increase light intensity, maintain light
intensity, decrease light intensity, increase light intensity, decrease light intensity, maintain light
intensity, increase light intensity, maintain light intensity, decrease light intensity.
Menashe8_A: set light intensity to high, decrease light intensity, increase light intensity,
decrease light intensity, maintain light intensity, increase light intensity, maintain light intensity,
decrease light intensity.
Menashe8_B: set light intensity to high, decrease light intensity, increase light intensity,
decrease light intensity, increase light intensity, decrease light intensity, maintain light intensity,
increase light intensity.

Input component(s) 231 may further include any number and type of cameras, such as depth-sensing cameras or capturing devices (e.g., Intel® RealSense™ depth-sensing camera) that are known for capturing still and/or video red-green-blue (RGB) and/or RGB-depth (RGB-D) images for media, such as personal media. Such images, having depth information, have been effectively used for various computer vision and computational photography effects, such as (without limitations) scene understanding, refocusing, composition, cinema-graphs, etc. Similarly, for example, displays may include any number and type of displays, such as integral displays, tensor displays, stereoscopic displays, etc., including (but not limited to) embedded or connected display screens, display devices, projectors, etc.

Input component(s) 231 may further include one or more of vibration components, tactile components, conductance elements, biometric sensors, chemical detectors, signal detectors, electroencephalography, functional near-infrared spectroscopy, wave detectors, force sensors (e.g., accelerometers), illuminators, eye-tracking or gaze-tracking system, head-tracking system, etc., that may be used for capturing any amount and type of visual data, such as images (e.g., photos, videos, movies, audio/video streams, etc.), and non-visual data, such as audio streams or signals (e.g., sound, noise, vibration, ultrasound, etc.), radio waves (e.g., wireless signals, such as wireless signals having data, metadata, signs, etc.), chemical changes or properties (e.g., humidity, body temperature, etc.), biometric readings (e.g., figure prints, etc.), brainwaves, brain circulation, environmental/weather conditions, maps, etc. It is contemplated that “sensor” and “detector” may be referenced interchangeably throughout this document. It is further contemplated that one or more input component(s) 231 may further include one or more of supporting or supplemental devices for capturing and/or sensing of data, such as illuminators (e.g., IR illuminator), light fixtures, generators, sound blockers, etc.

It is further contemplated that in one embodiment, input component(s) 231 may further include any number and type of context sensors (e.g., linear accelerometer) for sensing or detecting any number and type of contexts (e.g., estimating horizon, linear acceleration, etc., relating to a mobile computing device, etc.). For example, input component(s) 231 may include any number and type of sensors, such as (without limitations): accelerometers (e.g., linear accelerometer to measure linear acceleration, etc.); inertial devices (e.g., inertial accelerometers, inertial gyroscopes, micro-electro-mechanical systems (MEMS) gyroscopes, inertial navigators, etc.); and gravity gradiometers to study and measure variations in gravitation acceleration due to gravity, etc.

Further, for example, input component(s) 231 may include (without limitations): audio/visual devices (e.g., cameras, microphones, speakers, etc.); context-aware sensors (e.g., temperature sensors, facial expression and feature measurement sensors working with one or more cameras of audio/visual devices, environment sensors (such as to sense background colors, lights, etc.); biometric sensors (such as to detect fingerprints, etc.), calendar maintenance and reading device), etc.; global positioning system (GPS) sensors; resource requestor; and/or TEE logic. TEE logic may be employed separately or be part of resource requestor and/or an I/O subsystem, etc. Input component(s) 231 may further include voice recognition devices, photo recognition devices, facial and other body recognition components, voice-to-text conversion components, etc.

Similarly, output component(s) 233 may include dynamic tactile touch screens having tactile effectors as an example of presenting visualization of touch, where an embodiment of such may be ultrasonic generators that can send signals in space which, when reaching, for example, human fingers can cause tactile sensation or like feeling on the fingers. Further, for example and in one embodiment, output component(s) 233 may include (without limitation) one or more of light sources, display devices and/or screens, audio speakers, tactile components, conductance elements, bone conducting speakers, olfactory or smell visual and/or non/visual presentation devices, haptic or touch visual and/or non-visual presentation devices, animation display devices, biometric display devices, X-ray display devices, high-resolution displays, high-dynamic range displays, multi-view displays, and head-mounted displays (HMDs) for at least one of virtual reality (VR) and augmented reality (AR), etc.

It is contemplated that embodiment are not limited to any number or type of use-case scenarios, architectural placements, or component setups; however, for the sake of brevity and clarity, illustrations and descriptions are offered and discussed throughout this document for exemplary purposes but that embodiments are not limited as such. Further, throughout this document, “user” may refer to someone having access to one or more computing devices, such as computing device 100, and may be referenced interchangeably with “person”, “individual”, “human”, “him”, “her”, “child”, “adult”, “viewer”, “player”, “gamer”, “developer”, programmer”, and/or the like.

Communication/compatibility logic 209 may be used to facilitate dynamic communication and compatibility between various components, networks, computing devices, database(s) 225, and/or communication medium(s) 230, etc., and any number and type of other computing devices (such as wearable computing devices, mobile computing devices, desktop computers, server computing devices, etc.), processing devices (e.g., central processing unit (CPU), graphics processing unit (GPU), etc.), capturing/sensing components (e.g., non-visual data sensors/detectors, such as audio sensors, olfactory sensors, haptic sensors, signal sensors, vibration sensors, chemicals detectors, radio wave detectors, force sensors, weather/temperature sensors, body/biometric sensors, scanners, etc., and visual data sensors/detectors, such as cameras, etc.), user/context-awareness components and/or identification/verification sensors/devices (such as biometric sensors/detectors, scanners, etc.), memory or storage devices, data sources, and/or database(s) (such as data storage devices, hard drives, solid-state drives, hard disks, memory cards or devices, memory circuits, etc.), network(s) (e.g., Cloud network, Internet, Internet of Things, intranet, cellular network, proximity networks, such as Bluetooth, Bluetooth low energy (BLE), Bluetooth Smart, Wi-Fi proximity, Radio Frequency Identification, Near Field Communication, Body Area Network, etc.), wireless or wired communications and relevant protocols (e.g., Wi-Fi®, WiMAX, Ethernet, etc.), connectivity and location management techniques, software applications/websites, (e.g., social and/or business networking websites, business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “tool”, “circuitry”, and/or the like, may be referenced interchangeably and include, by way of example, software, hardware, and/or any combination of software and hardware, such as firmware. In one example, “logic” may refer to or include a software component that works with one or more of an operating system, a graphics driver, etc., of a computing device, such as computing device 100. In another example, “logic” may refer to or include a hardware component that is capable of being physically installed along with or as part of one or more system hardware elements, such as an application processor, a graphics processor, etc., of a computing device, such as computing device 100. In yet another embodiment, “logic” may refer to or include a firmware component that is capable of being part of system firmware, such as firmware of an application processor or a graphics processor, etc., of a computing device, such as computing device 100.

Further, any use of a particular brand, word, term, phrase, name, and/or acronym, such as “code”, “original code or beam or photons”, “returned signal”, “bounced back code or beam or photons”, “time of flight”, “TOF”, “pulse code modulation, “PCM”, “3D camera”, “LIDAR/RADAR 3D camera”, “correlation”, “RealSense™ camera”, “real-time”, “automatic”, “dynamic”, “user interface”, “camera”, “sensor”, “microphone”, “display screen”, “speaker”, “verification”, “authentication”, “privacy”, “user”, “user profile”, “user preference”, “sender”, “receiver”, “personal device”, “smart device”, “mobile computer”, “wearable device”, “IoT device”, “proximity network”, “cloud network”, “server computer”, etc., should not be read to limit embodiments to software or devices that carry that label in products or in literature external to this document.

It is contemplated that any number and type of components may be added to and/or removed from TOF mechanism 110 to facilitate various embodiments including adding, removing, and/or enhancing certain features. For brevity, clarity, and ease of understanding of TOF mechanism 110, many of the standard and/or known components, such as those of a computing device, are not shown or discussed here. It is contemplated that embodiments, as described herein, are not limited to any technology, topology, system, architecture, and/or standard and are dynamic enough to adopt and adapt to any future changes.

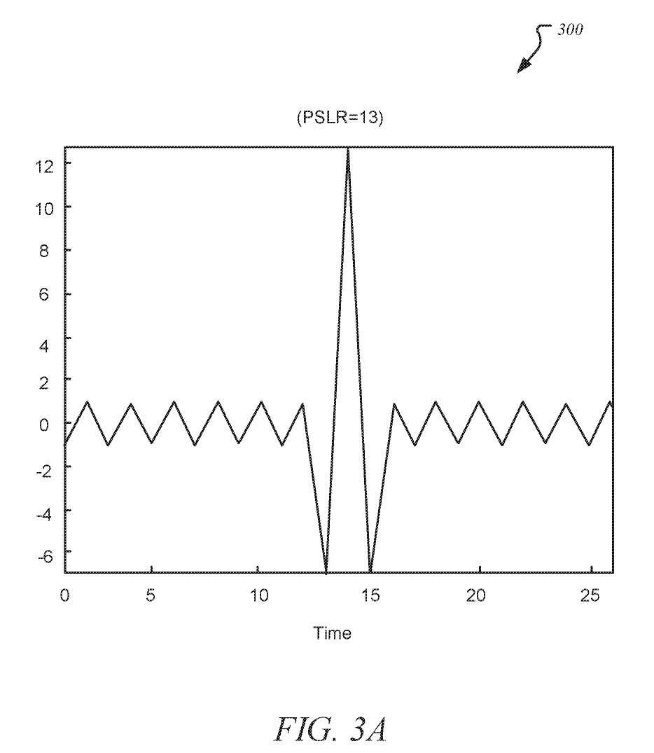

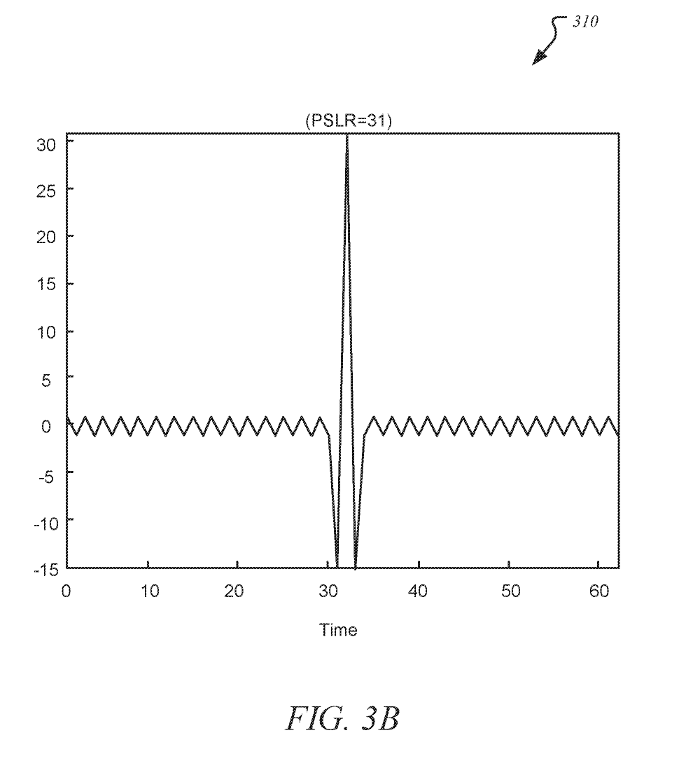

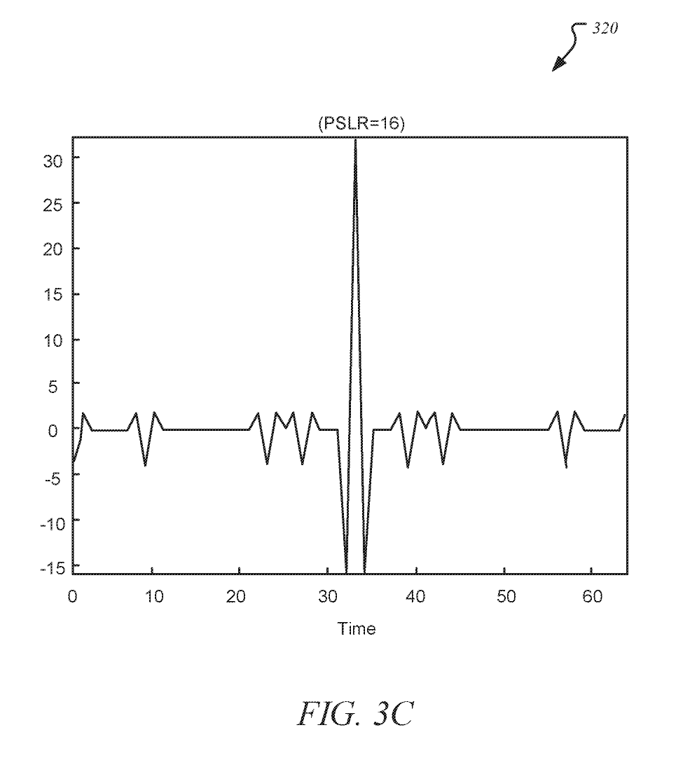

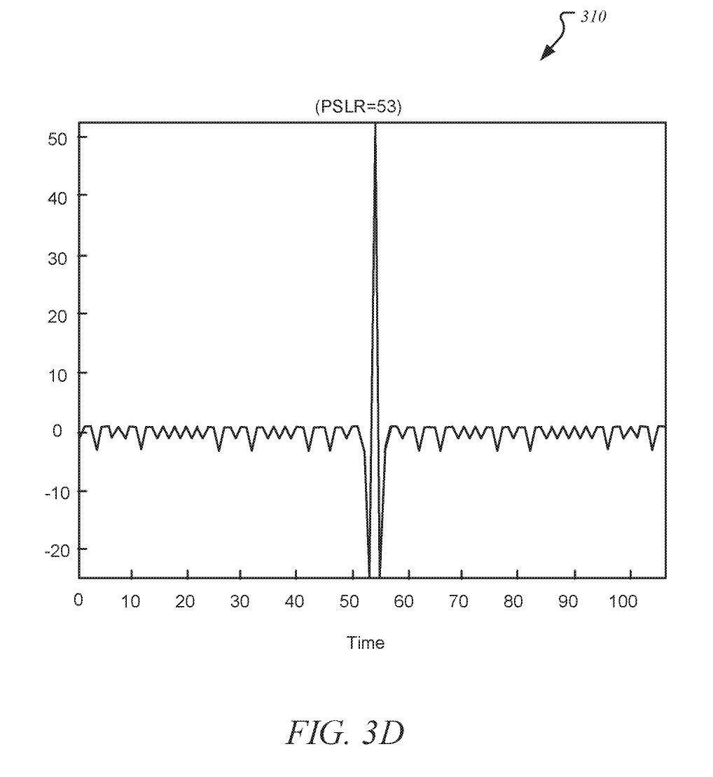

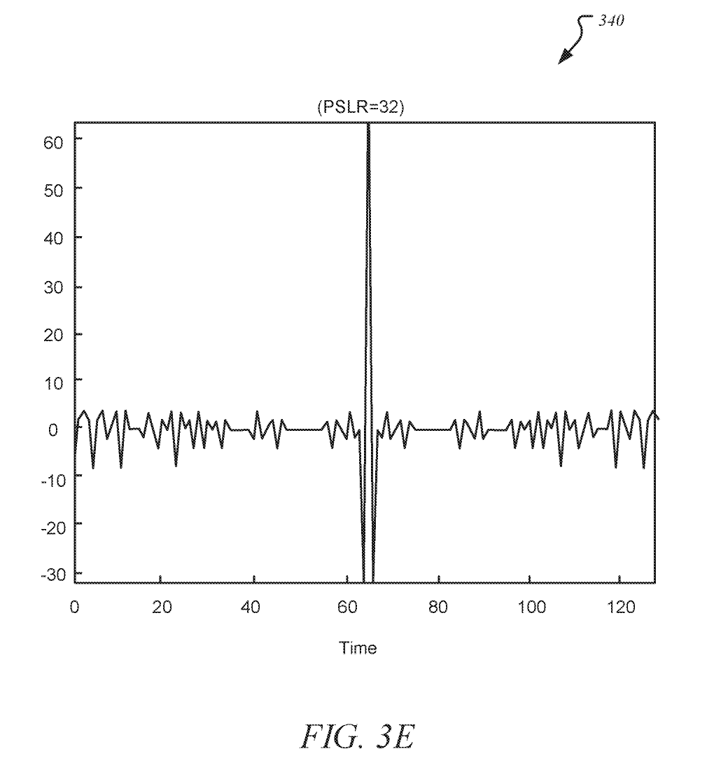

FIG. 3A illustrates a graph 300 representing workings and properties of a novel PCM-based binary code according to one embodiment. For brevity, many of the details previously discussed with reference to FIGS. 1-2 may not be discussed or repeated hereafter. In the illustrated embodiment, graph 300 shows the correlation of Menashe26* codes. Further, one of these codes is the Manchester-coded version of the B13 Barker code.

FIG. 3B illustrates a graph 310 representing workings and properties of a novel PCM-based binary code according to one embodiment. For brevity, many of the details previously discussed with reference to FIGS. 1-3A may not be discussed or repeated hereafter. In the illustrated embodiment, graph 310 shows that code may be flexibly designed in such a matter that it provides for an optimal PSLR of 31.

FIG. 3C illustrates a graph 320 representing workings and properties of a novel PCM-based binary code according to one embodiment. For brevity, many of the details previously discussed with reference to FIGS. 1-3B may not be discussed or repeated hereafter. In the illustrated embodiment, graph 320 shows that code may be flexibly designed in such a matter that is provides for a good PSLR of 16 and a better match for efficient digital implementation.

FIGS. 3D and 3E illustrate graphs 340 and 350, respectively, representing workings and properties of novel PCM-based binary codes according to one embodiment. For brevity, many of the details previously discussed with reference to FIGS. 1-3C may not be discussed or repeated hereafter. In the illustrated embodiments, graphs 340 and 350 are associated with codes that are flexibly designed in such a matter that they are suitable and efficient for extremely compute-intensive environments, such as in the space of space of 2̂N where N>100.

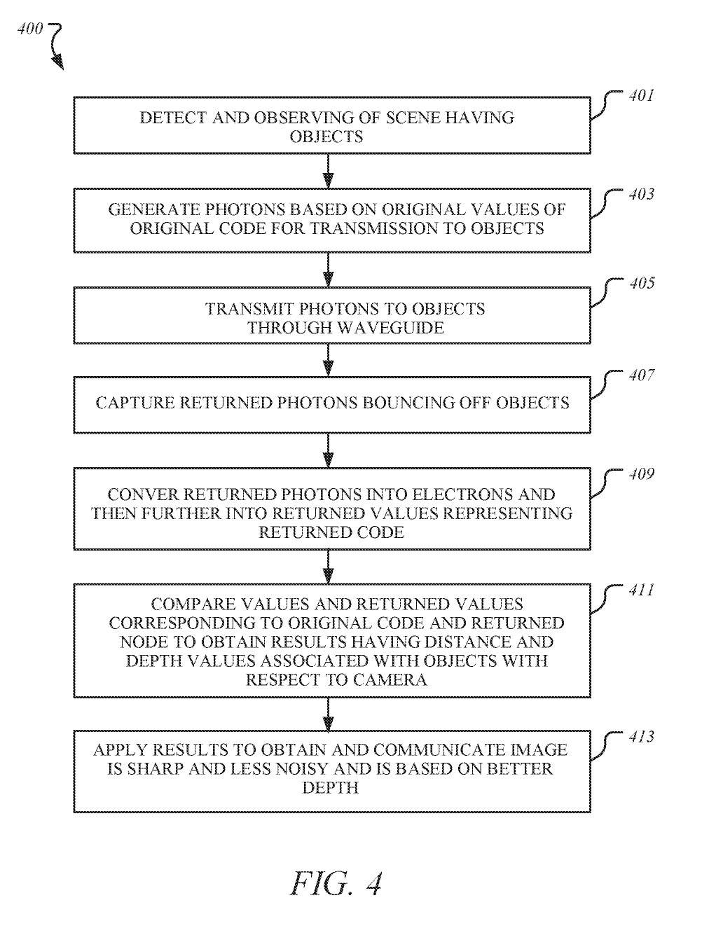

FIG. 4 illustrates a method 400 for facilitating maximizing efficiency of flight optical depth sensors in computing environments according to one embodiment. For brevity, many of the details previously discussed with reference to FIGS. 1-3E may not be discussed or repeated hereafter. Any processes or transactions may be performed by processing logic that may comprise hardware (e.g., circuitry, dedicated logic, programmable logic, etc.), software (such as instructions run on a processing device), or a combination thereof, as facilitated by TOF mechanism 110 of FIG. 1. Any processes or transactions associated with this illustration may be illustrated or recited in linear sequences for brevity and clarity in presentation; however, it is contemplated that any number of them can be performed in parallel, asynchronously, or in different orders.

Method 400 starts at block 401 with a camera of a computing device detecting, observing, and capturing a scene having objects. At block 403, a code is generated to be converted into a beam of photons to be used in transmission from the camera to one or more objects in the scene. At block 405, the beam of photons is transmitted one or more sensors associated with the camera to the one or more objects. At block 407, a returning (signal) beam of photos bouncing back from the one or more objects is captured by the one or more sensors. At block 409, the photons from the beam are converted into electrons that are then further converted into values (such as numbers).

In one embodiment, at block 411, these values captured from the captured beam representing the returned bounced back signal are then correlated or compared with the values from the original code to obtain results indicating the distance and depth associated with the one or more objects with respect to the camera. At block 413, these results are then applied to offer a realistic image of the scene to viewers, where this realistic image has better depth and is sharper, clearer, and less noisy.

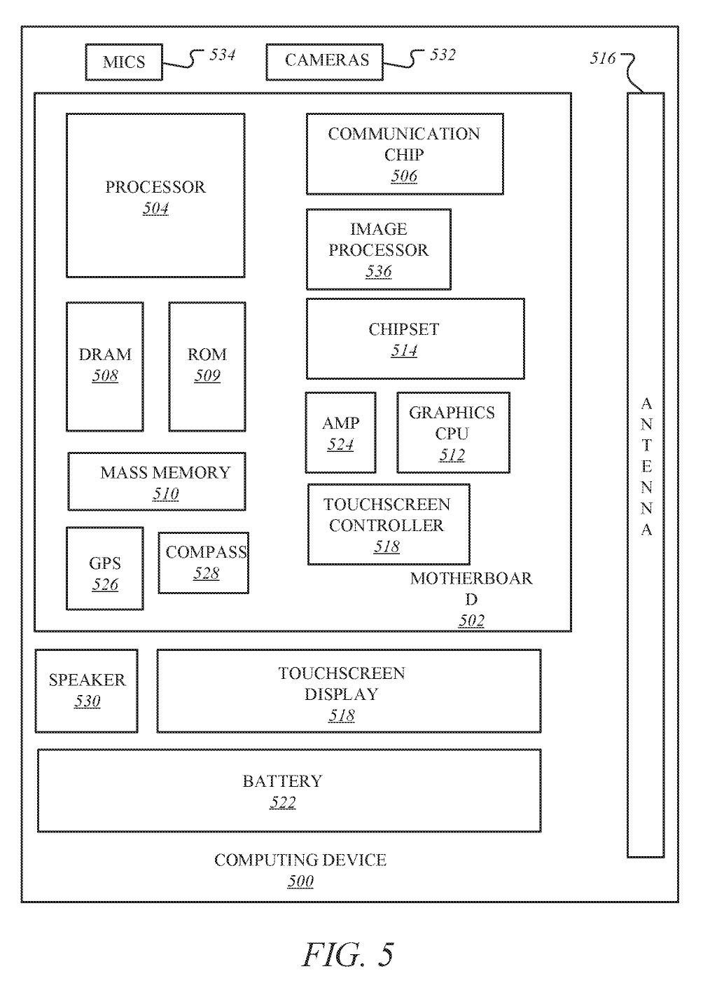

FIG. 5 illustrates a computing device 500 in accordance with one implementation. The illustrated computing device 500 may be same as or similar to computing device 100 of FIG. 1. The computing device 500 houses a system board 502. The board 502 may include a number of components, including but not limited to a processor 504 and at least one communication package 506. The communication package is coupled to one or more antennas 516. The processor 504 is physically and electrically coupled to the board 502.

Depending on its applications, computing device 500 may include other components that may or may not be physically and electrically coupled to the board 502. These other components include, but are not limited to, volatile memory (e.g., DRAM) 508, non-volatile memory (e.g., ROM) 509, flash memory (not shown), a graphics processor 512, a digital signal processor (not shown), a crypto processor (not shown), a chipset 514, an antenna 516, a display 518 such as a touchscreen display, a touchscreen controller 520, a battery 522, an audio codec (not shown), a video codec (not shown), a power amplifier 524, a global positioning system (GPS) device 526, a compass 528, an accelerometer (not shown), a gyroscope (not shown), a speaker 530, cameras 532, a microphone array 534, and a mass storage device (such as hard disk drive) 510, compact disk (CD) (not shown), digital versatile disk (DVD) (not shown), and so forth). These components may be connected to the system board 502, mounted to the system board, or combined with any of the other components.

The communication package 506 enables wireless and/or wired communications for the transfer of data to and from the computing device 500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication package 506 may implement any of a number of wireless or wired standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, Ethernet derivatives thereof, as well as any other wireless and wired protocols that are designated as 3G, 4G, 5G, and beyond. The computing device 500 may include a plurality of communication packages 506. For instance, a first communication package 506 may be dedicated to shorter range wireless communications such as Wi-Fi and Bluetooth and a second communication package 506 may be dedicated to longer range wireless communications such as GPS, EDGE, GPRS, CDMA, WiMAX, LTE, Ev-DO, and others.

The cameras 532 including any depth sensors or proximity sensor are coupled to an optional image processor 536 to perform conversions, analysis, noise reduction, comparisons, depth or distance analysis, image understanding and other processes as described herein. The processor 504 is coupled to the image processor to drive the process with interrupts, set parameters, and control operations of image processor and the cameras. Image processing may instead be performed in the processor 504, the graphics CPU 512, the cameras 532, or in any other device.

In various implementations, the computing device 500 may be a laptop, a netbook, a notebook, an ultrabook, a smartphone, a tablet, a personal digital assistant (PDA), an ultra mobile PC, a mobile phone, a desktop computer, a server, a set-top box, an entertainment control unit, a digital camera, a portable music player, or a digital video recorder. The computing device may be fixed, portable, or wearable. In further implementations, the computing device 500 may be any other electronic device that processes data or records data for processing elsewhere.

Embodiments may be implemented using one or more memory chips, controllers, CPUs (Central Processing Unit), microchips or integrated circuits interconnected using a motherboard, an application specific integrated circuit (ASIC), and/or a field programmable gate array (FPGA). The term “logic” may include, by way of example, software or hardware and/or combinations of software and hardware.

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

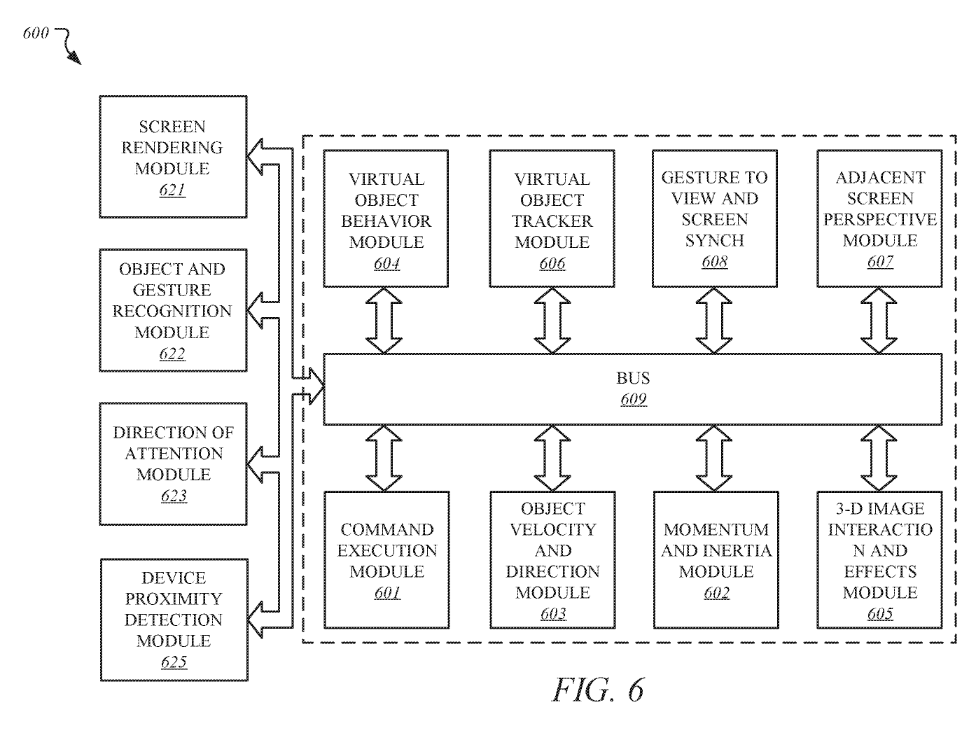

FIG. 6 illustrates an embodiment of a computing environment 600 capable of supporting the operations discussed above. The modules and systems can be implemented in a variety of different hardware architectures and form factors including that shown in FIG. 5.

The Command Execution Module 601 includes a central processing unit to cache and execute commands and to distribute tasks among the other modules and systems shown. It may include an instruction stack, a cache memory to store intermediate and final results, and mass memory to store applications and operating systems. The Command Execution Module may also serve as a central coordination and task allocation unit for the system.

The Screen Rendering Module 621 draws objects on the one or more multiple screens for the user to see. It can be adapted to receive the data from the Virtual Object Behavior Module 604, described below, and to render the virtual object and any other objects and forces on the appropriate screen or screens. Thus, the data from the Virtual Object Behavior Module would determine the position and dynamics of the virtual object and associated gestures, forces and objects, for example, and the Screen Rendering Module would depict the virtual object and associated objects and environment on a screen, accordingly. The Screen Rendering Module could further be adapted to receive data from the Adjacent Screen Perspective Module 607, described below, to either depict a target landing area for the virtual object if the virtual object could be moved to the display of the device with which the Adjacent Screen Perspective Module is associated. Thus, for example, if the virtual object is being moved from a main screen to an auxiliary screen, the Adjacent Screen Perspective Module 2 could send data to the Screen Rendering Module to suggest, for example in shadow form, one or more target landing areas for the virtual object on that track to a user's hand movements or eye movements.

The Object and Gesture Recognition Module 622 may be adapted to recognize and track hand and arm gestures of a user. Such a module may be used to recognize hands, fingers, finger gestures, hand movements and a location of hands relative to displays. For example, the Object and Gesture Recognition Module could for example determine that a user made a body part gesture to drop or throw a virtual object onto one or the other of the multiple screens, or that the user made a body part gesture to move the virtual object to a bezel of one or the other of the multiple screens. The Object and Gesture Recognition System may be coupled to a camera or camera array, a microphone or microphone array, a touch screen or touch surface, or a pointing device, or some combination of these items, to detect gestures and commands from the user.

The touch screen or touch surface of the Object and Gesture Recognition System may include a touch screen sensor. Data from the sensor may be fed to hardware, software, firmware or a combination of the same to map the touch gesture of a user's hand on the screen or surface to a corresponding dynamic behavior of a virtual object. The sensor date may be used to momentum and inertia factors to allow a variety of momentum behavior for a virtual object based on input from the user's hand, such as a swipe rate of a user's finger relative to the screen. Pinching gestures may be interpreted as a command to lift a virtual object from the display screen, or to begin generating a virtual binding associated with the virtual object or to zoom in or out on a display. Similar commands may be generated by the Object and Gesture Recognition System using one or more cameras without the benefit of a touch surface.

The Direction of Attention Module 623 may be equipped with cameras or other sensors to track the position or orientation of a user's face or hands. When a gesture or voice command is issued, the system can determine the appropriate screen for the gesture. In one example, a camera is mounted near each display to detect whether the user is facing that display. If so, then the direction of attention module information is provided to the Object and Gesture Recognition Module 622 to ensure that the gestures or commands are associated with the appropriate library for the active display. Similarly, if the user is looking away from all of the screens, then commands can be ignored.

The Device Proximity Detection Module 625 can use proximity sensors, compasses, GPS (global positioning system) receivers, personal area network radios, and other types of sensors, together with triangulation and other techniques to determine the proximity of other devices. Once a nearby device is detected, it can be registered to the system and its type can be determined as an input device or a display device or both. For an input device, received data may then be applied to the Object Gesture and Recognition Module 622. For a display device, it may be considered by the Adjacent Screen Perspective Module 607.

The Virtual Object Behavior Module 604 is adapted to receive input from the Object Velocity and Direction Module, and to apply such input to a virtual object being shown in the display. Thus, for example, the Object and Gesture Recognition System would interpret a user gesture and by mapping the captured movements of a user's hand to recognized movements, the Virtual Object Tracker Module would associate the virtual object's position and movements to the movements as recognized by Object and Gesture Recognition System, the Object and Velocity and Direction Module would capture the dynamics of the virtual object's movements, and the Virtual Object Behavior Module would receive the input from the Object and Velocity and Direction Module to generate data that would direct the movements of the virtual object to correspond to the input from the Object and Velocity and Direction Module.

The Virtual Object Tracker Module 606 on the other hand may be adapted to track where a virtual object should be located in three-dimensional space in a vicinity of a display, and which body part of the user is holding the virtual object, based on input from the Object and Gesture Recognition Module. The Virtual Object Tracker Module 606 may for example track a virtual object as it moves across and between screens and track which body part of the user is holding that virtual object. Tracking the body part that is holding the virtual object allows a continuous awareness of the body part's air movements, and thus an eventual awareness as to whether the virtual object has been released onto one or more screens.

The Gesture to View and Screen Synchronization Module 608, receives the selection of the view and screen or both from the Direction of Attention Module 623 and, in some cases, voice commands to determine which view is the active view and which screen is the active screen. It then causes the relevant gesture library to be loaded for the Object and Gesture Recognition Module 622. Various views of an application on one or more screens can be associated with alternative gesture libraries or a set of gesture templates for a given view. As an example, in FIG. 1A, a pinch-release gesture launches a torpedo, but in FIG. 1B, the same gesture launches a depth charge.

The Adjacent Screen Perspective Module 607, which may include or be coupled to the Device Proximity Detection Module 625, may be adapted to determine an angle and position of one display relative to another display. A projected display includes, for example, an image projected onto a wall or screen. The ability to detect a proximity of a nearby screen and a corresponding angle or orientation of a display projected therefrom may for example be accomplished with either an infrared emitter and receiver, or electromagnetic or photo-detection sensing capability. For technologies that allow projected displays with touch input, the incoming video can be analyzed to determine the position of a projected display and to correct for the distortion caused by displaying at an angle. An accelerometer, magnetometer, compass, or camera can be used to determine the angle at which a device is being held while infrared emitters and cameras could allow the orientation of the screen device to be determined in relation to the sensors on an adjacent device. The Adjacent Screen Perspective Module 607 may, in this way, determine coordinates of an adjacent screen relative to its own screen coordinates. Thus, the Adjacent Screen Perspective Module may determine which devices are in proximity to each other, and further potential targets for moving one or more virtual objects across screens. The Adjacent Screen Perspective Module may further allow the position of the screens to be correlated to a model of three-dimensional space representing all of the existing objects and virtual objects.

The Object and Velocity and Direction Module 603 may be adapted to estimate the dynamics of a virtual object being moved, such as its trajectory, velocity (whether linear or angular), momentum (whether linear or angular), etc. by receiving input from the Virtual Object Tracker Module. The Object and Velocity and Direction Module may further be adapted to estimate dynamics of any physics forces, by for example estimating the acceleration, deflection, degree of stretching of a virtual binding, etc. and the dynamic behavior of a virtual object once released by a user's body part. The Object and Velocity and Direction Module may also use image motion, size and angle changes to estimate the velocity of objects, such as the velocity of hands and fingers

The Momentum and Inertia Module 602 can use image motion, image size, and angle changes of objects in the image plane or in a three-dimensional space to estimate the velocity and direction of objects in the space or on a display. The Momentum and Inertia Module is coupled to the Object and Gesture Recognition Module 622 to estimate the velocity of gestures performed by hands, fingers, and other body parts and then to apply those estimates to determine momentum and velocities to virtual objects that are to be affected by the gesture.

The 3D Image Interaction and Effects Module 605 tracks user interaction with 3D images that appear to extend out of one or more screens. The influence of objects in the z-axis (towards and away from the plane of the screen) can be calculated together with the relative influence of these objects upon each other. For example, an object thrown by a user gesture can be influenced by 3D objects in the foreground before the virtual object arrives at the plane of the screen. These objects may change the direction or velocity of the projectile or destroy it entirely. The object can be rendered by the 3D Image Interaction and Effects Module in the foreground on one or more of the displays. As illustrated, various components, such as components 601, 602, 603, 604, 605. 606, 607, and 608 are connected via an interconnect or a bus, such as bus 609.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system for facilitating hybrid communication according to embodiments and examples described herein.

Some embodiments pertain to Example 1 that includes an apparatus to facilitate maximizing efficiency of time-of-flight optical depth sensors in computing environments, the apparatus comprising: detection and observation logic to facilitate a camera to detect and observe a scene and one or more objects in the scene; generation, transmission, and reception (GTR) logic to generate a beam of photons based on a transmitted code stored at a memory device, wherein the GTR logic to transmit the beam of photons to the one or more objects, and capture a beam of photons bouncing back from the one or more objects; and computation and correlation logic to correlate first values of the transmitted code with second values of a returned signal from the one or more objects as the beam of photons.

Example 2 includes the subject matter of Example 1, further comprising results application logic to obtain results from correlation of the first values and the second values corresponding to the transmitted code and the returned signal, respectively, and apply the results to create high quality depth image of the scene, wherein the depth image displayed at a display device is depth accurate and less noisy.

Example 3 includes the subject matter of Examples 1-2, wherein the beam of photons represents an optical version of the transmitted code, where the beam of photons is generated by activating a photon emitter, while the beam of photons is transmitted over to the one or more objects through an optical system.

Example 4 includes the subject matter of Examples 1-3, wherein the GTR logic is further to generate the returned signal by converting the beam of photons into electrons and further into the second values.

Example 5 includes the subject matter of Examples 1-4, wherein the results comprise information associated with depth and distance associated with the one or more objects with respect to a range-finding device or one or more sensors associated with the range-finding device.

Example 6 includes the subject matter of Examples 1-5, wherein the range-finding device comprises one or more of a point-ranger finder and a time of flight (TOF)-based three-dimensional (3D) camera, and wherein the transmitted code and the returned signals include binary codes and are based on a pulse code modulation (PCM) scheme.

Example 7 includes the subject matter of Examples 1-6, wherein the apparatus comprises one or more processors including a graphics processor co-located with an application processor on a common semiconductor package.

Some embodiments pertain to Example 8 that includes a method facilitating maximizing efficiency of time-of-flight optical depth sensors in computing environments, the method comprising: facilitating a camera of a computing device to detect and observe a scene and one or more objects in the scene; generating a beam of photons based on a transmitted code stored at a memory device; transmitting the beam of photons to the one or more objects, and capture a beam of photons bouncing back from the one or more objects; and correlating first values of the transmitted code with second values of a returned signal from the one or more objects as the beam of photons.

Example 9 includes the subject matter of Example 8, further comprising: obtaining results from correlation of the first values and the second values corresponding to the transmitted code and the returned signal, respectively; and applying the results to create high quality depth image of the scene, wherein the depth image displayed at a display device is depth accurate and less noisy.

Example 10 includes the subject matter of Examples 8-9, wherein the beam of photons represents an optical version of the transmitted code, where the beam of photons is generated by activating a photon emitter, while the beam of photons is transmitted over to the one or more objects through an optical system.

Example 11 includes the subject matter of Examples 8-10, further comprising generating the returned signal by converting the beam of photons into electrons and further into the second values.

Example 12 includes the subject matter of Examples 8-11, wherein the results comprise information associated with depth and distance associated with the one or more objects with respect to a range-finding device or one or more sensors associated with the range-finding device.

Example 13 includes the subject matter of Examples 8-12, wherein the range-finding device comprises one or more of a point-ranger finder and a time of flight (TOF)-based three-dimensional (3D) camera, and wherein the transmitted code and the returned signals include binary codes and are based on a pulse code modulation (PCM) scheme.

Example 14 includes the subject matter of Examples 8-13, wherein the computing device comprises one or more processors including a graphics processor co-located with an application processor on a common semiconductor package.

Some embodiments pertain to Example 15 that includes a data processing system comprising a computing device having a memory device coupled to a processing device, the processing device to perform operations comprising: facilitating a camera to detect and observe a scene and one or more objects in the scene; generating a beam of photons based on a transmitted code stored at a memory device; transmitting the beam of photons to the one or more objects, and capture a beam of photons bouncing back from the one or more objects; and correlating first values of the transmitted code with second values of a returned signal from the one or more objects as the beam of photons.

Example 16 includes the subject matter of Example 15, wherein the operations further comprise obtaining results from correlation of the first values and the second values corresponding to the transmitted code and the returned signal, respectively; and applying the results to create high quality depth image of the scene, wherein the depth image displayed at a display device is depth accurate and less noisy.

Example 17 includes the subject matter of Examples 15-16, wherein the beam of photons represents an optical version of the transmitted code, where the beam of photons is generated by activating a photon emitter, while the beam of photons is transmitted over to the one or more objects through an optical system.

Example 18 includes the subject matter of Examples 15-17, wherein the operations further comprise generating the returned signal by converting the beam of photons into electrons and further into the second values.

Example 19 includes the subject matter of Examples 15-18, wherein the results comprise information associated with depth and distance associated with the one or more objects with respect to a range-finding device or one or more sensors associated with the range-finding device.

Example 20 includes the subject matter of Examples 15-19, wherein the range-finding device comprises one or more of a point-ranger finder and a time of flight (TOF)-based three-dimensional (3D) camera, and wherein the transmitted code and the returned signals include binary codes and are based on a pulse code modulation (PCM) scheme.

Example 21 includes the subject matter of Examples 15-20, wherein the computing device comprises one or more processors including a graphics processor co-located with an application processor on a common semiconductor package.

Some embodiments pertain to Example 22 that includes an apparatus to facilitate maximizing efficiency of time-of-flight optical depth sensors in computing environments, the apparatus comprising: means for facilitating a camera to detect and observe a scene and one or more objects in the scene; means for generating a beam of photons based on a transmitted code stored at a memory device; means for transmitting the beam of photons to the one or more objects, and capture a beam of photons bouncing back from the one or more objects; and means for correlating first values of the transmitted code with second values of a returned signal from the one or more objects as the beam of photons.

Example 23 includes the subject matter of Example 22, further comprising means for obtaining results from correlation of the first values and the second values corresponding to the transmitted code and the returned signal, respectively, and means for applying the results to create high quality depth image of the scene, wherein the depth image displayed at a display device is depth accurate and less noisy.

Example 24 includes the subject matter of Examples 22-23, wherein the beam of photons represents an optical version of the transmitted code, where the beam of photons is generated by activating a photon emitter, while the beam of photons is transmitted over to the one or more objects through an optical system.

Example 25 includes the subject matter of Examples 22-24, further comprising means for generating the returned signal by converting the beam of photons into electrons and further into the second values.

Example 26 includes the subject matter of Examples 22-25, wherein the results comprise information associated with depth and distance associated with the one or more objects with respect to a range-finding device or one or more sensors associated with the range-finding device.

Example 27 includes the subject matter of Examples 22-26, wherein the range-finding device comprises one or more of a point-ranger finder and a time of flight (TOF)-based three-dimensional (3D) camera, and wherein the transmitted code and the returned signals include binary codes and are based on a pulse code modulation (PCM) scheme.

Example 28 includes the subject matter of Examples 22-27, wherein the apparatus comprises one or more processors including a graphics processor co-located with an application processor on a common semiconductor package.

Example 29 includes at least one non-transitory or tangible machine-readable medium comprising a plurality of instructions, when executed on a computing device, to implement or perform a method as claimed in any of claims or examples 8-14.

Example 30 includes at least one machine-readable medium comprising a plurality of instructions, when executed on a computing device, to implement or perform a method as claimed in any of claims or examples 8-14.

Example 31 includes a system comprising a mechanism to implement or perform a method as claimed in any of claims or examples 8-14.

Example 32 includes an apparatus comprising means for performing a method as claimed in any of claims or examples 8-14.

Example 33 includes a computing device arranged to implement or perform a method as claimed in any of claims or examples 8-14.

Example 34 includes a communications device arranged to implement or perform a method as claimed in any of claims or examples 8-14.

Example 35 includes at least one machine-readable medium comprising a plurality of instructions, when executed on a computing device, to implement or perform a method or realize an apparatus as claimed in any preceding claims.

Example 36 includes at least one non-transitory or tangible machine-readable medium comprising a plurality of instructions, when executed on a computing device, to implement or perform a method or realize an apparatus as claimed in any preceding claims.

Example 37 includes a system comprising a mechanism to implement or perform a method or realize an apparatus as claimed in any preceding claims.

Example 38 includes an apparatus comprising means to perform a method as claimed in any preceding claims.

Example 39 includes a computing device arranged to implement or perform a method or realize an apparatus as claimed in any preceding claims.

Example 40 includes a communications device arranged to implement or perform a method or realize an apparatus as claimed in any preceding claims.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An apparatus comprising:
detection and observation logic to facilitate a camera to detect and observe a scene and one or more objects in the scene;
generation, transmission, and reception (GTR) logic to generate a beam of photons based on a transmitted code stored at a memory device, wherein the GTR logic to transmit the beam of photons to the one or more objects, and capture a beam of photons bouncing back from the one or more objects; and
computation and correlation logic to correlate first values of the transmitted code with second values of a returned signal from the one or more objects as the beam of photons.

2. The apparatus of claim 1, further comprising results application logic to obtain results from correlation of the first values and the second values corresponding to the transmitted code and the returned signal, respectively, and apply the results to create high quality depth image of the scene, wherein the depth image displayed at a display device is depth accurate and less noisy.

3. The apparatus of claim 1, wherein the beam of photons represents an optical version of the transmitted code, where the beam of photons is generated by activating a photon emitter, while the beam of photons is transmitted over to the one or more objects through an optical system.

4. The apparatus of claim 1, wherein the GTR logic is further to generate the returned signal by converting the beam of photons into electrons and further into the second values.

5. The apparatus of claim 2, wherein the results comprise information associated with depth and distance associated with the one or more objects with respect to a range-finding device or one or more sensors associated with the range-finding device.

6. The apparatus of claim 5, wherein the range-finding device comprises one or more of a point-ranger finder and a time of flight (TOF)-based three-dimensional (3D) camera, and wherein the transmitted code and the returned signals include binary codes and are based on a pulse code modulation (PCM) scheme.

7. The apparatus of claim 1, wherein the apparatus comprises one or more processors including a graphics processor co-located with an application processor on a common semiconductor package.

8. A method comprising:
facilitating a camera of a computing device to detect and observe a scene and one or more objects in the scene;
generating a beam of photons based on a transmitted code stored at a memory device;
transmitting the beam of photons to the one or more objects, and capture a beam of photons bouncing back from the one or more objects; and
correlating first values of the transmitted code with second values of a returned signal from the one or more objects as the beam of photons.

9. The method of claim 8, further comprising:
obtaining results from correlation of the first values and the second values corresponding to the transmitted code and the returned signal, respectively; and
applying the results to create high quality depth image of the scene, wherein the depth image displayed at a display device is depth accurate and less noisy.

10. The method of claim 8, wherein the beam of photons represents an optical version of the transmitted code, where the beam of photons is generated by activating a photon emitter, while the beam of photons is transmitted over to the one or more objects through an optical system.

11. The method of claim 8, further comprising generating the returned signal by converting the beam of photons into electrons and further into the second values.

12. The method of claim 9, wherein the results comprise information associated with depth and distance associated with the one or more objects with respect to a range-finding device or one or more sensors associated with the range-finding device.

13. The method of claim 12, wherein the range-finding device comprises one or more of a point-ranger finder and a time of flight (TOF)-based three-dimensional (3D) camera, and wherein the transmitted code and the returned signals include binary codes and are based on a pulse code modulation (PCM) scheme.

14. The method of claim 8, wherein the computing device comprises one or more processors including a graphics processor co-located with an application processor on a common semiconductor package.

15. At least one machine-readable medium comprising instructions which, when executed by a computing device, cause the computing device to perform operations comprising:
facilitating a camera to detect and observe a scene and one or more objects in the scene;
generating a beam of photons based on a transmitted code stored at a memory device;
transmitting the beam of photons to the one or more objects, and capture a beam of photons bouncing back from the one or more objects; and
correlating first values of the transmitted code with second values of a returned signal from the one or more objects as the beam of photons.

16. The machine-readable medium of claim 15, further comprising:
obtaining results from correlation of the first values and the second values corresponding to the transmitted code and the returned signal, respectively; and
applying the results to create high quality depth image of the scene, wherein the depth image displayed at a display device is depth accurate and less noisy.

17. The machine-readable medium of claim 15, wherein the beam of photons represents an optical version of the transmitted code, where the beam of photons is generated by activating a photon emitter, while the beam of photons is transmitted over to the one or more objects through an optical system.

18. The machine-readable medium of claim 15, wherein the operations further comprise generating the returned signal by converting the beam of photons into electrons and further into the second values.

19. The machine-readable medium of claim 16, wherein the results comprise information associated with depth and distance associated with the one or more objects with respect to a range-finding device or one or more sensors associated with the range-finding device.

20. The machine-readable medium of claim 19, wherein the range-finding device comprises one or more of a point-ranger finder and a time of flight (TOF)-based three-dimensional (3D) camera, and wherein the transmitted code and the returned signals include binary codes and are based on a pulse code modulation (PCM) scheme, wherein the computing device comprises one or more processors including a graphics processor co-located with an application processor on a common semiconductor package.
